(19) United States
(12) Patent Application Publication
(10) Pub. No.: US 2006/0039498 A1
(43) Pub. Date: Feb. 23, 2006

(54) Pre-distorter for orthogonal frequency division multiplexing systems and method of operating the same

(76) Inventors: Rui J. P. de Figueiredo, Irvine, CA (US); Byung Moo Lee, Irvine, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/205,937

(22) Filed: Aug. 17, 2005

Related U.S. Application Data
(60) Provisional application No. 60/602,905, filed on Aug. 19, 2004.

(51) Int. Cl. H04L 25/49

(52) U.S. Cl. 375/297; 375/296

(57) ABSTRACT

A pre-distorter and a power amplifier are combined in a communication system. The purpose of the power amplifier is to provide as high a power as possible to the orthogonal frequency division multiplexing (OFDM) signal being passed by the high power amplifier to the communication system. The pre-distorter inverts the nonlinearity of the amplifier, so that the combination of pre-distorter and high power amplifier exhibit a linear characteristic beyond the normal linear range of the high power amplifier. The pre-distorter is based on exact analytic expression for the description of the input-output characteristic of the pre-distorter based on an analytic model for the power amplifier. A mixed computational-analytical approach compensates for nonlinear distortion in the high power amplifier even with time-varying characteristics. This leads to a sparse and yet accurate representation of the pre-distorter, with the capability of tracking efficiently any rapidly time-varying behavior of the power amplifier.

### RELATED APPLICATIONS

The present application is related to U.S. Provisional Patent Application Ser. No. 60/602,905, filed on Aug. 19, 2004, which is incorporated herein by reference and to which priority is claimed pursuant to 35 USC 119.

### BACKGROUND OF THE INVENTION

1. Field of the Invention

The invention relates to the field of pre-distorters in communications systems using power amplifiers in which the signal-dependent and time-varying parameters of the power amplifier are linearized by means of the pre-distorter.

2. Description of the Prior Art

Orthogonal frequency-division multiplexing (OFDM) is a method of digital modulation in which a signal is split into several narrowband channels at different frequencies. The technology was first conceived in the 1960s and 1970s during research into minimizing interference among channels near each other in frequency. In some respects, OFDM is similar to conventional frequency-division multiplexing (FDM). The difference lies in the way in which the signals are modulated and demodulated. Priority is given to minimizing the interference, or crosstalk, among the channels and symbols comprising the data stream. Less importance is placed on perfecting individual channels. OFDM is used in European digital audio broadcast services. The technology lends itself to digital television, and is being considered as a method of obtaining high-speed digital data transmission over conventional telephone lines. It is also used in wireless local area networks.

Orthogonal frequency division multiplexing (OFDM) has several desirable attributes, such as high immunity to inter-symbol interference, robustness with respect to multi-path fading, and ability for high data rates. These features are making OFDM to be incorporated in emerging wireless standards like IEEE 802.11a WLAN and ETSI terrestrial broadcasting. However, one of the major problems posed by OFDM is its high peak-to-average-power ratio (PAPR), which seriously limits the power efficiency of the high power amplifier (HPA) because of the nonlinear distortion caused by high peak-to-average-power ratio. This distortion constitutes a source of major concern to the RF system design community.

One of the most promising approaches for the mitigation of this nonlinear distortion is to use a pre-distorter, applied to the OFDM signal prior to its entry into the high power amplifier. For the most part previous pre-distorter-based approaches consisted of: (1) using a look-up table (LUT) and updating the table via least mean square (LMS) error estimation; (2) two-stage estimation, using Wiener-type system modeling for the high power amplifier, and Hammerstein system modeling for the pre-distorter; (3) simplified Volterra-based modeling for compensation of the high power amplifier nonlinearity; and (4) polynomial approximation of this nonlinearity.

However, all of these techniques are based on a general approximation form for the nonlinear system, rather than on exploiting specific forms gleaned from physical device considerations.

In the case of the look-up table, it is updated by an adaptive algorithm. This has the disadvantage of inherent quantization noise caused by the limited size of look up table and a long time involved in the update of look-up table after estimating the high power amplifier.

In the case of the two-stage estimation, the estimation is utilized to estimate parameters of Wiener system to first estimate high power amplifier and then to estimate parameters for pre-distorter with the information of parameters for high power amplifier. This has the disadvantage of requiring a lot of time for the convergence of parameter estimates.

In the case of using a Volterra-based pre-distorter, this approach utilizes direct as well as indirect learning structure to train the coefficients more efficiently. This has the disadvantage of complexity in the modeling and estimation of Volterra series.

In the case of using polynomial approximation for high power amplifier and pre-distorter, the algorithm is generic, but it has the disadvantage of complexity incurred by polynomial approximation.

In the case of using an exact inverse model of traveling wave tube amplifier this has the disadvantage of not fitting time varying high power amplifier systems.

All of these techniques described above are based on a general approximation form for the nonlinear system, rather than on exploiting specific forms gleaned from physical device considerations.

### BRIEF SUMMARY OF THE INVENTION

The pre-distorter of the invention can be used any kind of wireless communications, e.g. cellular phone, digital video broadcasting, digital audio broadcasting, or any kind of wireline communications, e.g., a digital subscriber line (DSL) to enhance the power transmitted by a high power amplifier with the least nonlinear distortion. The invention can have immediate future use in hand-held wireless communication devices and in digital satellite communications.

The invention is a pre-distorter. The pre-distorter is an electronic nonlinear signal processing device, which is placed before the high power amplifier, which in turn is connected to the transmitting antenna of a wireless communication system. The purpose of the high power amplifier is to provide as high a power as possible to the OFDM signal being passed by the high power amplifier to the transmitting antenna. However, a large increase in power forces the signal in the high power amplifier to go beyond the linear range of the high power amplifier. In order to enable this increase in power at the output of the high power amplifier while minimizing distortion, a pre-distorter is inserted before the amplifier. The pre-distorter inverts the nonlinearity of the amplifier, so that the combination of pre-distorter and high power amplifier exhibit a linear characteristic beyond the normal linear range of the high power amplifier. This process is called linearization.

The special feature of the illustrated invention is that the design of the pre-distorter is based on exact analytic expression for the description of the input-output characteristic of the pre-distorter based on an analytic model for the high power amplifier. This permits accuracy and efficiency in the performance of the above linearization task by the OFDM signal transmission system.

The fundamental principle governing the application is that orthogonal frequency division multiplexing has several desirable attributes which makes it a prime candidate for a number of emerging wireless communication standards, e.g. IEEE 802.11a and g WLAM and ETSI terrestrial broadcasting. However, one of the major problems posed by the OFDM signal is its high peak-to-average-power ratio, which seriously limits the power efficiency of the high power amplifier because of the nonlinear distortion resulting from high peak-to-average-power ratio.

The illustrated embodiment provides a new mixed computational-analytical approach for compensation of this nonlinear distortion for the cases in which the high power amplifier is a traveling wave tube amplifier (TWTA) or a solid state power amplifier (SSPA) with time-varying characteristic. Traveling wave tube amplifiers are used in wireless communication systems when high transmission power is required as in the case of the digital satellite channel, and solid state power amplifiers are used for land-based mobile wireless communication systems. Compared to previous pre-distorter techniques based on look-up table or adaptive schemes, the illustrated embodiment relies on the analytical inversion of the Saleh traveling wave tube amplifier model and Rapp's solid state power amplifier model in combination with a nonlinear parameter estimation algorithm. This leads to a sparse and yet accurate representation of the pre-distorter, with the capability of tracking efficiently any rapidly time-varying behavior of the high power amplifier. Computer simulations results illustrate and validate the approach presented.

In the illustrated embodiment, we describe a new approach to pre-distorter for high power amplifier by using the Saleh traveling wave tube amplifier model and Rapp's solid state power amplifier model for these devices and resorting to the exact closed form expression for its inverse represented by means of only a few parameters. This approach avoids a larger number of parameters that a generic approximation expression (like the polynomial approximation) would require for accurate representation.

In the illustrated approach, we capitalize on the analytical model for the solid state power amplifier and traveling wave tube amplifier to derive cogent algorithms for two pre-distorters labeled respectively pre-distorter I and pre-distorter II. The pre-distorter I algorithm applies to the solid state power amplifier and pre-distorter II to traveling wave tube amplifier.

The reason we use these two types of high power amplifiers is that these two types are very important for today's wireless communication systems. traveling wave tube amplifiers are normally used for satellite communications, and solid state power amplifiers are used for mobile communication systems. Considerable work on distortion compensation has been done for the traveling wave tube amplifier, because of severe nonlinearity of this type of amplifier. However, OFDM is expected to be a standard for next generation cellular systems in a combined form with code-division multiple access (CDMA) i.e. multiple carrier code-division multiple access (MC-CDMA) or multiple carrier direct sequence code-division multiple access (MC-DS-CDMA). Code-division multiple access is a digital cellular technology that uses spread-spectrum techniques. Unlike competing systems, CDMA does not assign a specific frequency to each user. Instead, every channel uses the full available spectrum. Individual conversations are encoded with a pseudo-random digital sequence. CDMA consistently provides better capacity for voice and data communications than other commercial mobile technologies, allowing more subscribers to connect at any given time. Multi-Carrier (MC) CDMA is a combined technique of Direct Sequence (DS) CDMA (Code Division Multiple Access) and OFDM techniques. It applies spreading sequences in the frequency domain.

Therefore, the importance of solid state power amplifier will be then much greater than now. For this reason we also use a solid state power amplifier as a high power amplifier model. While a closed form expression for the inverse of the Saleh model is known, this inverse was not used in the implementation of their pre-distorter in the illustrated embodiment in which the characteristic of the high power amplifier is time-varying. We have combined the closed form expression for the inverse of the high power amplifier characteristic with a sequential nonlinear parameter estimation algorithm, which allows sparse implementation of the pre-distorter and accurate tracking of or adaptation to the time varying behavior of the high power amplifier.

Compared to the other prior art approaches mentioned above, our algorithms are fast, accurate, and of low complexity as demonstrated and verified by the computer simulations described below.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a simplified OFDM communications transmitter with a pre-distorter and high power amplifier of the invention.

FIG. 2 is a graph of the nonlinear amplitude and phase transfer function of the Saleh's traveling wave tube amplifier model showing normalized output as a function of normalized input.

FIG. 3 is a graph of the nonlinear amplitude transfer function of the Rapp's solid state power amplifier model showing normalized output as a function of normalized input.

FIG. 4 is a graph of the amplitude compensation effect of Saleh's traveling wave tube amplifier model with a pre-distorter showing normalized output as a function of normalized input.

FIG. 5 is a simplified block diagram of a pre-distorter combined with a time varying high power amplifier.

FIG. 6a is a graph of the compensation effect of Rapp's solid state power amplifier model using a pre-distorter showing normalized output as a function of normalized input.

FIG. 6b is a graph of the compensation and clipping effect of Rapp's solid state power amplifier model using a pre-distorter showing normalized output as a function of normalized input.

FIG. 7a is a graph of the received OFDM signal constellations with a traveling wave tube amplifier without a pre-distorter showing I channel vs Q channel

FIG. 7b is a graph of the received OFDM signal constellations with a traveling wave tube amplifier with a pre-distorter showing I channel vs Q channel.

FIG. 8 is a graph showing the bit error ratio (BER) output performance with and without a pre-distorter in an OFDM system with a time-invariant traveling wave tube amplifier showing BER as a function of input E_{b}/N₀ ratio in db where E_{b} is the signal energy per bit and N₀ is the noise power spectral density. That is E_{b}/N₀=SNR (Signal to Noise Ratio).

FIG. 9a is a graph of the signal amplitude in the saturation condition where the normalized signal is clipped above 1 showing normalized output as a function of normalized input.

FIG. 9b is a graph of the signal phase in the saturation condition. This figure shows normalized input amplitude vs output phase distortion, since output phase distortion is a function of normalized input amplitude

FIG. 10 is a graph showing BER output performance with and without a pre-distorter in an OFDM system with a time-varying traveling wave tube amplifier with parameters are uniformly distributed with IBO (Input Back-Off)=6 dB in which the pre-distorter is provided with and without tracking showing BER as a function of input E_{b}/N₀ ratio in db where E_{b} is the signal energy per bit and N₀ is the noise power spectral density. That is E_{b}/N₀=SNR (Signal to Noise Ratio)

FIG. 11 is a graph showing BER output performance with and without a pre-distorter in an OFDM system with a time-varying traveling wave tube amplifier with parameters are uniformly distributed with IBO=7 dB in which the pre-distorter is provided with and without tracking showing BER as a function of input E_{b}/N₀ ratio in db where E_{b} is the signal energy per bit and N₀ is the noise power spectral density. That is E_{b}/N₀=SNR (Signal to Noise Ratio)

FIG. 12a is a graph of the received OFDM signal constellations with a solid state power amplifier without a pre-distorter showing I channel vs Q channel.

FIG. 12b is a graph of the received OFDM signal constellations with a solid state power amplifier with a pre-distorter showing I channel vs Q channel.

FIG. 13 is a graph of BER performance of a pre-distorter in an OFDM system with a time-invariant solid state power amplifier, when A₀=p=1 showing BER as a function of input E_{b}/N₀ ratio in db where E_{b} is the signal energy per bit and N₀ is the noise power spectral density. That is E_{b}/N₀=SNR

(Signal to Noise Ratio)

FIG. 14 is a graph of BER performance of a pre-distorter, when the parameters are uniformly distributed in the range 1≦·A₀≦·1.5, 1≦·p≦·1.5, with IBO=6 dB showing BER as a function of input E_{b}/N₀ ratio in db where E_{b} is the number of bit errors and N₀ the total number of input bits.

FIG. 15 is a graph of BER performance of a pre-distorter, when the parameters are uniformly distributed in the range 1≦·A₀≦·2, 1≦··p≦··2 with IBO=6 dB showing BER as a function of input E_{b}/N₀ ratio in db where E_{b} is the signal energy per bit and N₀ is the noise power spectral density. That is E_{b}/N₀=SNR (Signal to Noise Ratio)

FIG. 16 is a graph of BER performance of a pre-distorter, when the parameters are uniformly distributed in the range 1≦·A₀≦·2, 1≦··p≦·2 with IBO=7 dB showing BER as a function of input E_{b}/N₀ ratio in db where E_{b} is the signal energy per bit and N₀ is the noise power spectral density. That is E_{b}/N₀=SNR (Signal to Noise Ratio)

FIG. 17 shows convergence of two changing parameters with Gaussian and uniformly distributed, β, ε in Saleh's TWTA model

FIG. 18 is a graph showing BER output performance with and without a pre-distorter in an OFDM system with a time-varying traveling wave tube amplifier with parameters are both Gaussian and uniformly distributed with IBO (Input Back-Off)=6 dB in which the pre-distorter is provided with and without tracking showing BER as a function of input E_{b}/N₀ ratio in db where E_{b} is the signal energy per bit and N₀ is the noise power spectral density. That is E_{b}/N₀=SNR (Signal to Noise Ratio)

FIG. 19 is a graph showing BER output performance with and without a pre-distorter in an OFDM system with a time-varying traveling wave tube amplifier with parameters are both Gaussian and uniformly distributed with IBO (Input Back-Off)=7 dB in which the pre-distorter is provided with and without tracking showing BER as a function of input E_{b}/N₀ ratio in db where E_{b} is the signal energy per bit and N₀ is the noise power spectral density. That is E_{b}/N₀=SNR (Signal to Noise Ratio)

FIG. 20 shows convergence of two changing parameters with Gaussian distributed, A₀, p in Rapp's SSPA model (mean=1.5, variance=0.01)

FIG. 21 is a graph of BER performance of a pre-distorter, when the parameters are Gaussian distributed, variance=0.1 with IBO=6 dB showing BER as a function of input E_{b}/N₀ ratio in db where E_{b} is the signal energy per bit and N₀ is the noise power spectral density. That is E_{b}/N₀=SNR (Signal to Noise Ratio)

FIG. 22 is a graph of BER performance of a pre-distorter, when the parameters are Gaussian distributed, variance=0.1 with IBO=7 dB showing BER as a function of input E_{b}/N₀ ratio in db where E_{b} is the signal energy per bit and N₀ is the noise power spectral density. That is E_{b}/N₀=SNR (Signal to Noise Ratio)

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

System Description

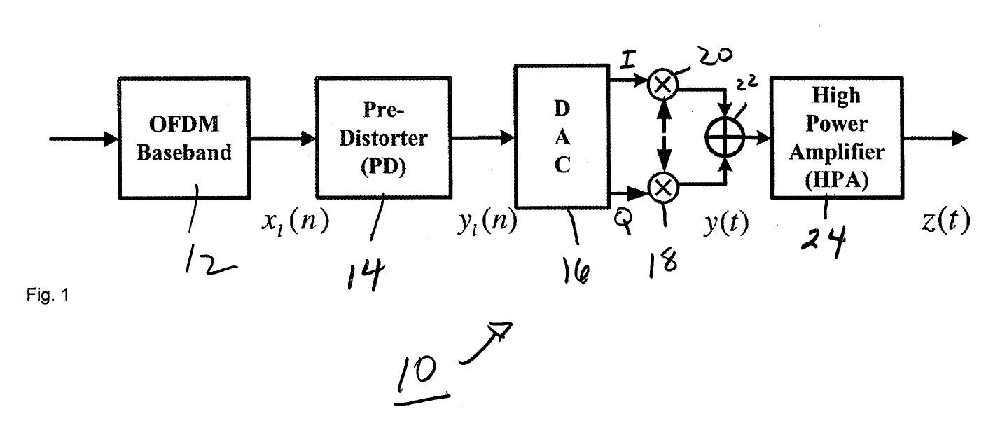

FIG. 1 is a simplified block diagram of the invention showing a system architecture, generally denoted by reference numeral 10, for compensation of the high power amplifier nonlinearity for an OFDM system. The OFDM baseband module 12 generates an OFDM-formatted signal to pre-distorter 14, whose digital output is converted to analog form by digital to analog converter 16 to produce phase shifted QAM outputs to multipliers 18 and 20 which are combined and summed in adder 22 and then input to power amplifier 24 for transmission to the wireless or wireline communication system. It must be understood that the hardware in FIG. 1 can be implemented in a number of equivalent ways. For example pre-distorter 14 is a digital circuit which may be a dedicated digital signal processor using a combination of hardware and/or firmware, or may be a computer with appropriate signal interfaces which computer arranged and configured by software to process digital information as taught by the invention. There is no limitation on the specific technology by which pre-distorter 14 may be realized and all means now known or later devised are expressly contemplated as being within the scope of the invention.

Typically, an OFDM signal x(t) can be analytically represented as

$$x ( t ) = \frac{1}{\sqrt{N}} {\sum }_{k = 0}^{N - 1} X [ k ] {ⅇ}^{j2π {f}_{k} t} \qquad ( 1 )$$

where X[k] denotes quadrature amplitude modulation (QAM) symbol, N is the number of sub-carriers, and fₖ is kth sub-carrier frequency which can be represented as

$${f}_{k} = k \cdot \frac{1}{{NT}_{s}} \qquad ( 2 )$$
where Ts is sampling period of x(t). QAM is a method of combining two amplitude-modulated (AM) signals into a single channel, thereby doubling the effective bandwidth. QAM is used with pulse amplitude modulation (PAM) in digital systems, especially in wireless applications. In a QAM signal, there are two carriers, each having the same frequency but differing in phase by 90 degrees (one quarter of a cycle, from which the term quadrature arises). One signal is called the I signal, and the other is called the Q signal. Mathematically, one of the signals can be represented by a sine wave, and the other by a cosine wave. The two modulated carriers are combined at the source for transmission. At the destination, the carriers are separated, the data is extracted from each, and then the data is combined into the original modulating information.

By discretizing x(t) at t=nTs, we have the equation

$$x ( n ) ≡ x ( {nT}_{s} ) = \frac{1}{\sqrt{N}} {\sum }_{k = 0}^{N - 1} X [ k ] {ⅇ}^{\frac{j2π kn}{N}} \qquad ( 3 )$$

The pre-distorter 14 is a nonlinear zero memory device that pre-computes and cancels the nonlinear distortion present in the zero memory high power amplifier 24 which follows the pre-distorter 14.

Traveling Wave Tube Amplifier Model

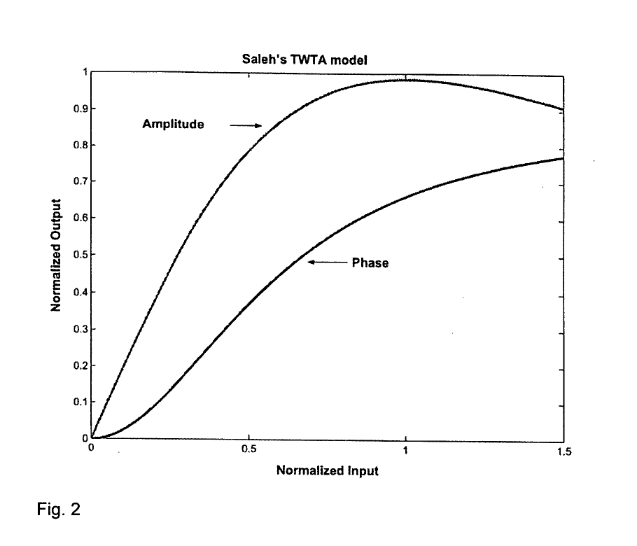

As a high power amplifier model, we show Saleh's well established traveling wave tube amplifier model. In this model, AM/AM and AM/PM conversion of traveling wave tube amplifier can be represented as

$$u [ r ] = \frac{α r}{1 + β {r}^{2}} \\ Φ [ r ] = \frac{γ {r}^{2}}{1 + ɛ {r}^{2}} \qquad ( 4 ) , ( 5 )$$

where u is amplitude response, φ is phase response, r is input amplitude of the traveling wave tube amplifier and α, β, γ, and ε are four adjustable parameters. The behavior of equations (4) and (5) is illustrated in the graph of FIG. 2, where normalized output of the traveling wave tube amplifier is shown as a function of normalized input. In FIG. 2, we use α=1.9638; β=0.9945; γ=2.5293; and ε=2.8168 as in Saleh's original work. The output z(t) of traveling wave tube amplifier 24 without pre-distorter 14 can be represented as
   z(t)=u[r]cos(ω_{c}t+φ(t)+Φ[r]) (6)
where φ(t) is the phase of the input signal and ω_{c} is carrier frequency.
   Solid State Power Amplifier Model

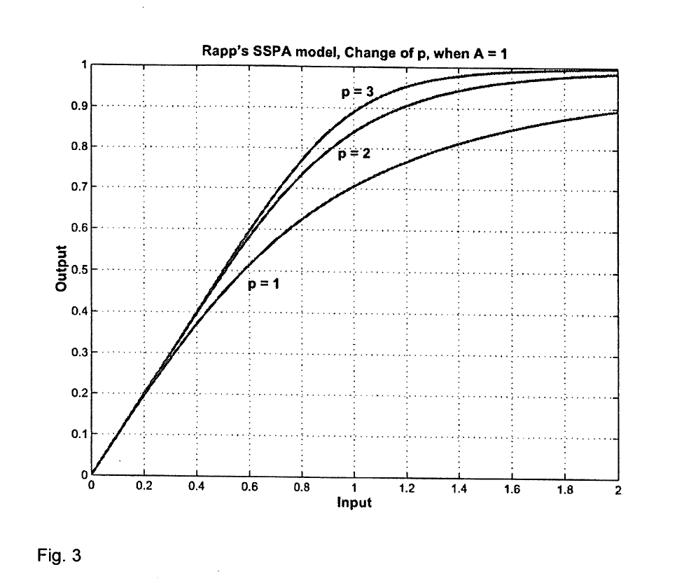

For the solid state power amplifier 24, we use normalized Rapp's model. In this model, we assume AM/PM conversion is small enough, so that it can be neglected. Then, AM/AM and AM/PM conversion of solid state power amplifier can be represented as

$$\begin{matrix}u [ r ] = \frac{r}{{( 1 + {( \frac{r}{{A}_{0}} )}^{2 p} )}^{\frac{1}{2 p}}} \\ Φ [ r ] \approx 0\end{matrix} \qquad ( 7 ) , ( 8 )$$

where r is input amplitude of solid state power amplifier 24, A₀ is the maximum output amplitude and p is the parameter which affects the smoothness of the transition. The behavior of equation (7) is illustrated in the graph of FIG. 3 where normalized output is shown as a function of normalized input. The output z(t) of solid state power amplifier 24 without pre-distorter 14 can be represented as
   z(t)=u[r] cos(ω_{c}t+φ(t)) (9)
where φ(t) is the phase of the input signal.
   Pre-Distorters

Now consider the pre-distorters 14 for both traveling wave tube amplifier 24 and solid state power amplifier 24 according to the invention. Let q and u denote the nonlinear zero memory input and output maps respectively of the pre-distorter 14 and high power amplifier 24, and xₗ(n), the input of the pre-distorter 14, yₗ(n), the output of the pre-distorter 14 which is also the input to the high power amplifier 24, and z(t) the output of the high power amplifier 24 as shown in FIG. 1. Then for any given high power amplifier 24, an ideal pre-distorter 14 according to the invention is one for which the input-output maps satisfies
u[q(xₗ(n))]=k xₗ(n) (10)
where k is a desired pre-specified linear amplification constant. In this illustration, we assume k=1.
   Pre-Distorter for Traveling Wave Tube Amplifier
   Time-Invariant Case

In traveling wave tube amplifier 24, the general baseband (equivalent low pass signal) expressions for the input xₗ(n) and output yₗ(n) of the pre-distorter 14 are
xₗ(n)=r(n)e^{jφ(n)} (11),
yₗ(n)=q[r(n)]e^{j(φ(n)+θ[r(n)])} (12)
where the function q and φ are to be determined by requiring that equation (10) be satisfied. According to equations (4) and (5), the input and output of traveling wave tube amplifier 24 are
   y(t)=q[r(t)] cos(ω_{c}t+φ(t)+θ[r(t)]) (13),
   z(t)=[q[r(t)]]cos(ω_{c}t+φ(t)+θ[r(t)]+Φ[q(t)] (14)
where

$$u [ q ( r ) ] = \frac{α q}{1 + β {q}^{2}} \\ Φ [ q ( r ) ] = \frac{γ {q}^{2}}{1 + ɛ {q}^{2}} \qquad ( 15 ) , ( 16 )$$

In order to satisfy (10), the following must hold

$$\frac{α q}{1 + β {q}^{2}} = r \\ \frac{γ {q}^{2}}{1 + ɛ {q}^{2}} = - θ \qquad ( 17 ) , ( 18 )$$

From equation (17)
rβq²−αq+r=0 (19)

This equation can be solved for q to yield

$$q ( r ) = \frac{α - \sqrt{{α}^{2} - 4 {r}^{2} β}}{2 r β} , r \leq 1 \qquad ( 20 )$$

Also for zero phase distortion, we must have

$$\begin{matrix}θ ( r ) + Φ ( q ) = 0 \\ or & ( 21 ) \\ θ ( r ) = - Φ ( q ) = - \frac{{γ ( q ( r ) )}^{2}}{1 + {ɛ ( q ( r ) )}^{2}} & ( 22 )\end{matrix}$$

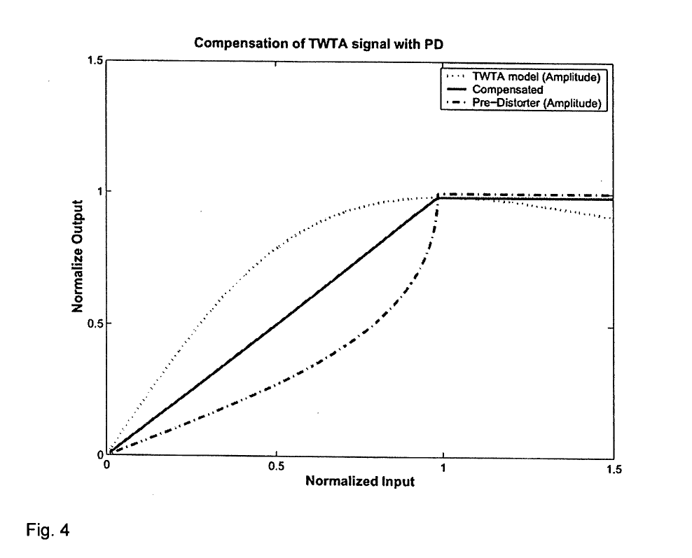

If r>1, equation (20) has no solution. This corresponds to the clipping of the signal according to the depiction of the graph of FIG. 4 where the normalized output is shown as a function of the normalized input for a traveling wave tube amplifier 24 with pre-distorter 14. This analytical solution of equations (20), (22) was previously obtained by Brajal and Chouly.

Time-Varying Adaptive Case

We now extend this solution to the time-varying case as follows. As a time-varying model, we assume four parameters α, β, γ, and ε change with time. We express

$$J ( α , β ) = {E ( \frac{α q}{1 + β {q}^{2}} - u )}^{2} \qquad ( 23 )$$

Where J is a cost function which should be minimized, E is expectation w.r.t α,β. Partially differentiating with respect to α and equating the result to zero, we get

$$\begin{matrix}\frac{\partial J ( α , β )}{\partial α} = E [ 2 ( \frac{α q}{1 + β {q}^{2}} - u ) \frac{q}{1 + β {q}^{2}} ] = 0 , & ( 24 ) \\ α E ( \frac{{q}^{2}}{{( 1 + β {q}^{2} )}^{2}} ) = E ( \frac{qu}{1 + β {q}^{2}} ) & ( 25 )\end{matrix}$$

Proceeding similarly with respect to β, we get

$$\begin{matrix}\frac{\partial J ( α , β )}{\partial β} = E [ 2 ( \frac{α q}{1 + β {q}^{2}} - u ) ( - \frac{α q}{{( 1 + β {q}^{2} )}^{2}} ) {q}^{2} ] = 0 \\ or & ( 26 ) \\ α E ( \frac{{q}^{4}}{{( 1 + β {q}^{2} )}^{3}} ) = E ( \frac{{q}^{3} u}{{( 1 + β {q}^{2} )}^{2}} ) & ( 27 )\end{matrix}$$

Let us define the following for the sake of simplicity.

$$\begin{matrix}A ( β ) = E ( \frac{{q}^{2}}{{( 1 + β {q}^{2} )}^{2}} ) , & ( 28 ) \\ B ( β ) = E ( \frac{qu}{1 + β {q}^{2}} ) , & ( 29 ) \\ C ( β ) = E ( \frac{{q}^{4}}{{( 1 + β {q}^{2} )}^{3}} ) , & ( 30 ) \\ D ( β ) = E ( \frac{{q}^{3} u}{{( 1 + β {q}^{2} )}^{2}} ) & ( 31 )\end{matrix}$$

According to equations (25), (28) and (29)

$$α = \frac{B ( β )}{A ( β )} \qquad ( 32 )$$

and according to equations (27), (30), (31), (32)

$$\frac{B ( β )}{A ( β )} C ( β ) = D ( β ) \qquad ( 33 )$$

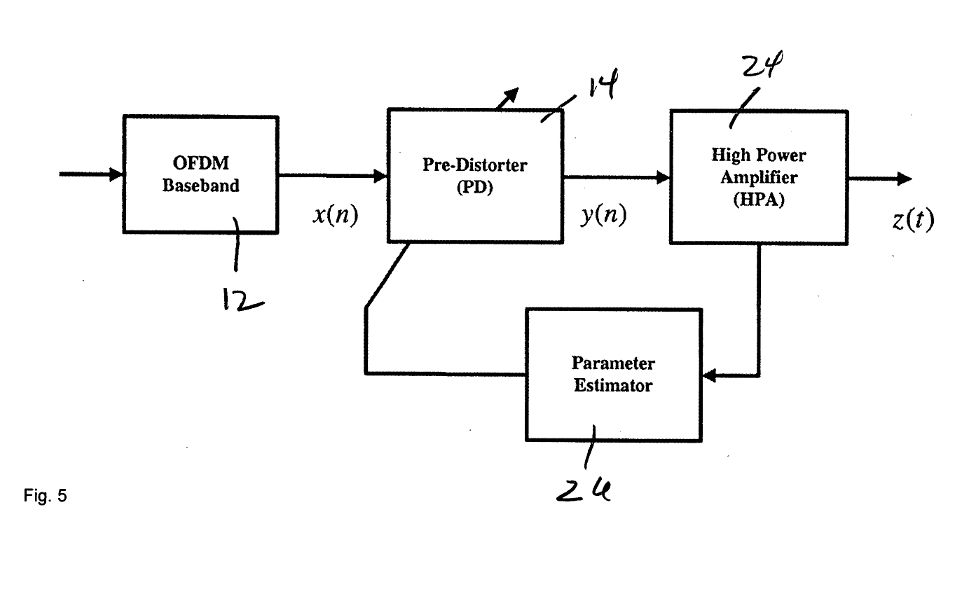

So, our approach is: Solve equation (33) in an estimator 26 shown in FIG. 5 numerically for \hat{β}, which is the estimate of β, and then replace \hat{β} in equation (32) to obtain \hat{α} the estimate of α. The expectation in equations (28), (29), (30), (31) can be estimated using the following equations

$$\begin{matrix}\hat{A} ( β ) = \frac{1}{N} {\sum }_{n = 1}^{N} \frac{{q}_{n}^{2}}{{( 1 + β {q}_{n}^{2} )}^{2}} , & ( 34 ) \\ \hat{B} ( β ) = \frac{1}{N} {\sum }_{n = 1}^{N} \frac{{q}_{n} {u}_{n}}{1 + β {q}_{n}^{2}} , & ( 35 ) \\ \hat{C} ( β ) = \frac{1}{N} {\sum }_{n = 1}^{N} \frac{{q}_{n}^{4}}{{( 1 + β {q}_{n}^{2} )}^{3}} , & ( 36 ) \\ \hat{D} ( β ) = \frac{1}{N} {\sum }_{n = 1}^{N} \frac{{q}_{n}^{3} {u}_{n}}{{( 1 + β {q}_{n}^{2} )}^{2}} & ( 37 )\end{matrix}$$

γ and ε also can be estimated exactly in the same way as described above. This approach is illustrated in the block diagram of FIG. 5 which shows a pre-distorter 14 for a time varying high power amplifier where a parameter estimator 26 is provided to take parameters from high power amplifier 24 and provide them to estimator 26 to generate parameter estimates for pre-distorter 14.

To get the optimum estimation of 18 from (33), we use the following equation.
\hat{β}ₒₚₜ=min _{β}|B(β)C(β)−A(β)D(β)|² (38)

The optimum coefficient \hat{β}ₒₚₜ, satisfying (38) is determined in order to minimize the MSE (Mean Square Error) defined by
J(β)=E[\hat{B}(β)\hat{C}(β)−\hat{A}(β)\hat{D}(β)]² (39)
Where J is cost function to be minimized and E is expectation w.r.t β

Then, derivative J w.r.t. β

$$\frac{\partial J ( β )}{\partial β} = 2 E ( \hat{B} ( β ) \hat{C} ( β ) - \hat{A} ( β ) \hat{D} ( β ) ) \cdot ( \frac{\partial \hat{B} ( β )}{\partial β} \hat{C} ( β ) + \hat{B} ( β ) \frac{\partial \hat{C} ( β )}{\partial β} - \frac{\partial \hat{A} ( β )}{\partial β} \hat{D} ( β ) - \hat{A} ( β ) \frac{\partial \hat{D} ( β )}{\partial β} ) \qquad ( 40 )$$

Where

$$\begin{matrix}\frac{\partial \hat{A} ( β )}{\partial β} = - \frac{2}{N} {\sum }_{n = 1}^{N} \frac{{q}_{n}^{4}}{{( 1 + β {q}_{n}^{2} )}^{3}} & ( 41 ) \\ \frac{\partial \hat{B} ( β )}{\partial β} = - \frac{1}{N} {\sum }_{n = 1}^{N} \frac{{q}_{n}^{3} {u}_{n}}{{( 1 + β {q}_{n}^{2} )}^{2}} & ( 42 ) \\ \frac{\partial \hat{C} ( β )}{\partial β} = - \frac{3}{N} {\sum }_{n = 1}^{N} \frac{{q}_{n}^{6}}{{( 1 + β {q}_{n}^{2} )}^{4}} & ( 43 ) \\ \frac{\partial \hat{D} ( β )}{\partial β} = - \frac{2}{N} {\sum }_{n = 1}^{N} \frac{{q}_{n}^{5} {u}_{n}}{{( 1 + β {q}_{n}^{2} )}^{3}} & ( 44 )\end{matrix}$$

After that, LMS (Least Mean Square) algorithm can be represented as

$$\hat{β} ( n + 1 ) = \hat{β} ( n ) - {μ}_{\hat{β}} \cdot ( \hat{B} ( \hat{β} ( n ) ) \hat{C} ( \hat{β} ( n ) ) - \hat{A} ( \hat{β} ( n ) ) \hat{D} ( \hat{β} ( n ) ) ) \cdot ( \frac{\partial \hat{B} ( \hat{β} ( n ) )}{\partial \hat{β} ( n )} \hat{C} ( \hat{β} ( n ) ) + \hat{B} ( \hat{β} ( n ) ) \frac{\partial \hat{C} ( \hat{β} ( n ) )}{\partial \hat{β} ( n )} - \frac{\partial \hat{A} ( \hat{β} ( n ) )}{\partial \hat{β} ( n )} \hat{D} ( \hat{β} ( n ) ) - \hat{A} ( \hat{β} ( n ) ) \frac{\partial \hat{D} ( \hat{β} ( n ) )}{\partial \hat{β} ( n )} ) \qquad ( 45 )$$

Where μ_{\hat{β}} is the step size of LMS algorithm.

Once we get estimation of β, we easily get estimation of α from (32). γ and ε can be estimated exactly same way described above.

Pre-Distorter for a Solid State Power Amplifier

Time-Invariant Case

As in traveling wave tube amplifier 24, the general baseband (equivalent low pass signal) expressions for the input xₗ(n) and output yₗ(n) of the pre-distorter 14 for solid state power amplifier 24 are
xₗ(n)=r(n)e^{jφ(n)} (46),
yₗ(n)=q[r(n)]e^{jφ(n)} (47)
where the function q and (are to be determined by requiring that equation (10) be satisfied. As we assume phase distortion is neglected, we don't need to regard phase pre-distortion. According to equations (7) and (8), the input and output of solid state power amplifier 24 are
   y_{c}(t)=q[r(t)] cos(ω_{c}t+φ(t)) (48),
   z(t)=u[q[r(t)]]cos(ω_{c}t+φ(t)) (49)
where

$$u [ q ( r ) ] = \frac{q ( r )}{{( 1 + {( \frac{q ( r )}{{A}_{0}} )}^{2 p} )}^{\frac{1}{2 p}}} \qquad ( 50 )$$

According to equation (50), equation (10) implies

$$\frac{q ( r )}{{( 1 + {( \frac{q ( r )}{{A}_{0}} )}^{2 p} )}^{\frac{1}{2 p}}} = r \qquad ( 51 )$$

Then, after some algebraic manipulation, we can find the exact expression for the pre-distorter characteristic q(r):

$$q ( r ) = \frac{r}{{( 1 - {( \frac{r}{{A}_{0}} )}^{2 p} )}^{\frac{1}{2 p}}} , r < {A}_{0} \qquad ( 52 )$$

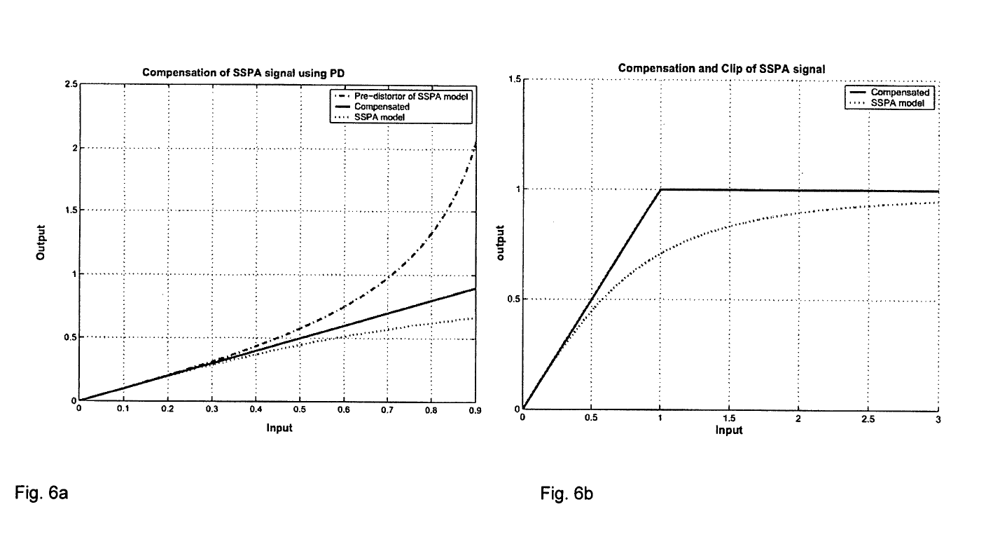

An illustration of compensation effect is shown in FIG. 6. When r>A₀, equation (52) has no solution. In this case, we clip the input signal as in FIG. 6.

Time-Varying Adaptive Case

Since high power amplifier 24 is time-varying system, as a time-varying model, we assume parameters A₀ and p in the solid state power amplifier model change with time. To track two parameters A₀ and p, we use training symbols. Using training symbols, we get input of pre-distorter 14, q(n), and output of pre-distorter 14, u(n). During the training stage, we assume pre-distorter 14 is turned off. That is, input and output of pre-distorter 14 would be same (r(n)=q(n)).

To estimate parameters A₀ and p, first, we change equation (50) as

$${A}_{0} = \frac{q \cdot u}{{( {q}^{2 p} - {u}^{2 p} )}^{\frac{1}{2 p}}} \qquad ( 53 )$$

To summarize the algorithm, if we know p, we can get A₀ easily from equation (53). However, we assume both A₀ and p change with time. First, send two training symbols, then we know the input amplitude q and the output amplitude u of the high power amplifier 24. Then from equation (53), corresponding to two different training symbols, we can get two different estimations of A₀, namely A₀₁ and A₀₂ as given by equations (54) and (55) below. If we choose a correct p, which is the same for high power amplifier 24 during the training time, the two different values of A₀, namely A₀₁ and A₀₂, have almost the same value or due to step size, very close values. We can find p for that point, which has the smallest distance between two estimated A₀, namely Dₘᵢₙ=|A₀₁−A₀₂|². Then, from equation (53) and the estimation of p, we can get Â₀=A₀₁≈A₀₂ from the minimum distance Dₘᵢₙ=|A₀₁−A₀₂|². This algorithm is computationally effortless. We use only two training symbols and no iteration, hence incurring very little delay.

Brief description of the Algorithm

1. Send two training symbols.
2. Get two estimated values of A₀, A₀₁ and A₀₂ from equation (53).
3. Choose a step size for p and find Dₘᵢₙ = |A₀₁ − A₀₂| ² to get
corresponding p which yields \hat{p}.
4. Get estimated value of A₀, Â₀, which is Â₀ = A₀₁ ≈ A₀₂

As a more practical way, if we know p, we can get A₀ easily from equation (53). However, we assume both A₀ and p change with time. In this case, we propose following algorithm. First, send two training symbols, then we know input amplitude of high power amplifier 24, q and output amplitude of high power amplifier 24, u. After that, from equation (53), correspond to two different training symbols, we get two different estimations of A₀, namely A₀₁ and A₀₂.

$$\begin{matrix}{A}_{01} = \frac{{q}_{1} \cdot {u}_{1}}{{( {q}_{1}^{2 p} - {u}_{1}^{2 p} )}^{\frac{1}{2 p}}} , & ( 54 ) \\ {A}_{02} = \frac{{q}_{2} \cdot {u}_{2}}{{( {q}_{2}^{2 p} - {u}_{2}^{2 p} )}^{\frac{1}{2 p}}} & ( 55 )\end{matrix}$$

where q₁, u₁ are output amplitudes of pre-distorter 14 and high power amplifier 24 respectively for first training symbol and q₂, u₂ are output amplitudes of pre-distorter 14 and high power amplifier 24 respectively for the second training symbol. Training symbols are not affected by the function of pre-distorter 14 as we stated previously. During training period, we can replace q, and q₂ as r₁ and r₂ which are the original amplitudes of training symbols. We can estimate unknown A₀ and p using following equations.
   \hat{p}ₒₚₜ=minₚA₀₁(p)−A₀₂(p)|² (56),
   Â₀=A₀₁(\hat{p}ₒₚₜ)≈A₀₂(\hat{p}ₒₚₜ) (57)
where Â₀ is an estimator of A₀ and \hat{p}opt is the optimum \hat{p} which we can get from equation (56).
   Simulation Results and Discussion

Consider now a test of the illustrated pre-distortion technique for compensation of high power amplifier nonlinear distortion as demonstrated with computer simulations. The additive white gaussian noise (AWGN) channels were assumed to clearly observe the effect of nonlinearity and performance improvement by the illustrated pre-distorter 14. An OFDM system 10 with 128 subcarriers and 16 QAMs is considered. If the input amplitude is very high, the high power amplifier 24 operates in a highly nonlinear situation. If the input amplitude is very small, the high power amplifier 24 operates with very small distortion. In the operation of high power amplifier 24, a relative level of power back off is needed to reduce distortion. However, this power back off is not so desirable because it reduces power efficiency. In our algorithm, a compensation solution always exists in the range r<A₀, where A₀ is maximum output amplitude. So, if the input average power is same as A₀², we get maximum power efficiency, but a highly nonlinear result. Thus, we need a criterion to show how much power back off from optimum power efficiency is needed. In the simulations, we define IBO (Input Back-Off) as

$$IBO = 10 {log}_{10} ( \frac{{A}_{0}^{2}}{{P}_{i n}} ) \qquad ( 58 )$$

where Pin is input average power (average power of OFDM signal). Similarly, we can also define OBO (Output Back-Off) as

$$OBO = 10 {log}_{10} ( \frac{{A}_{0}^{2}}{{P}_{out}} ) \qquad ( 59 )$$
where Pₒᵤₜ is output average power (average output power of high power amplifier 24).
   Pre-Distorter for Traveling Wave Tube Amplifier

Time-Invariant Case

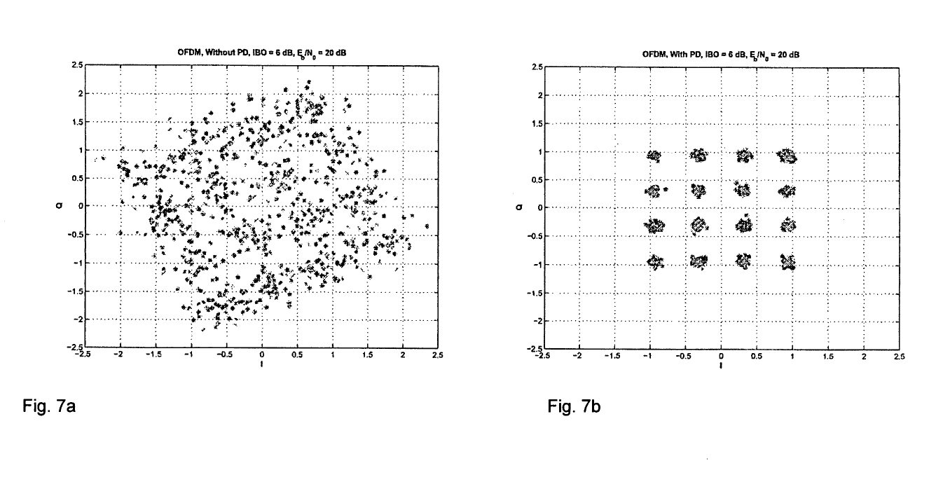

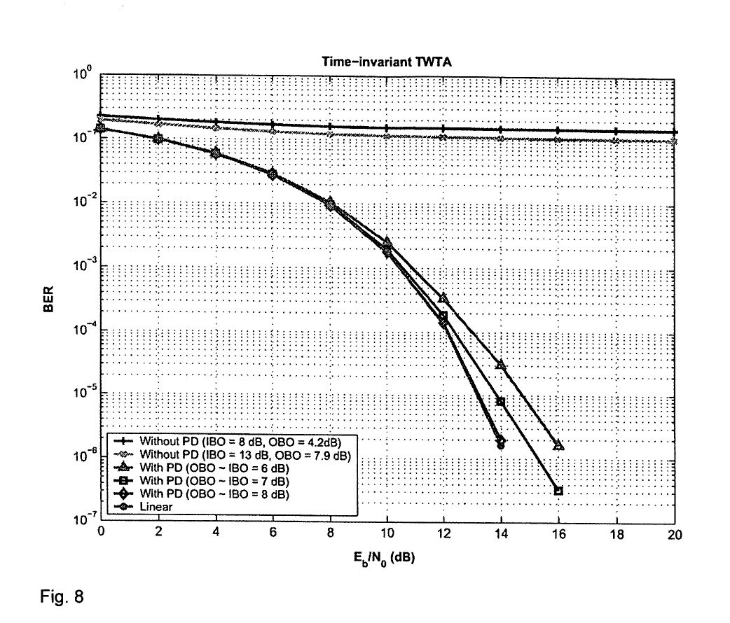

Consider now OFDM simulation results with the assumption that parameters α, β, γ, and ε are time invariant. FIGS. 7a and 7b are graphs which depict α as a function of I and which show the difference of signal constellation without and with pre-distorter 14 respectively. In FIGS. 7a and 7b, we use IBO=6 dB. The bit error rate or bit error ratio (BER) performance curve, shown in the graph of FIG. 8, shows BER as a function of Eb/N0 where Eb is the signal energy per bit and N₀ is noise power spectral density, and shows that the pre-distorter 14 can significantly reduce nonlinear distortion in an OFDM system 10. BER is the number of erroneous bits divided by the total number of bits transmitted, received, or processed over some stipulated period. Examples of bit error ratio are (a) transmission BER, i.e., the number of erroneous bits received divided by the total number of bits transmitted; and (b) information BER, i.e., the number of erroneous decoded (corrected) bits divided by the total number of decoded (corrected) bits. The BER is usually expressed as a coefficient and a power of 10; for example, 2.5 erroneous bits out of 100,000 bits transmitted would be 2.5 out of 10⁵ or 2.5×10⁻⁵.

Time-Varying Adaptive Case with Uniform Distribution

As mentioned previously, high power amplifier 24 is a time varying system. Assume the four parameters α, β, γ, and ε are now time-varying, thus we should track the variations of α, β, γ, and ε. We assume that these four parameters change with uniform distribution according to the following conditions.

(1) The four parameters change in the following ranges
1.01≦α0≦2 (60)
0.01≦β≦1 (61)
1.5<γ, ε·≦3 (62)

(2) Input and output normalization condition, β=α−1.

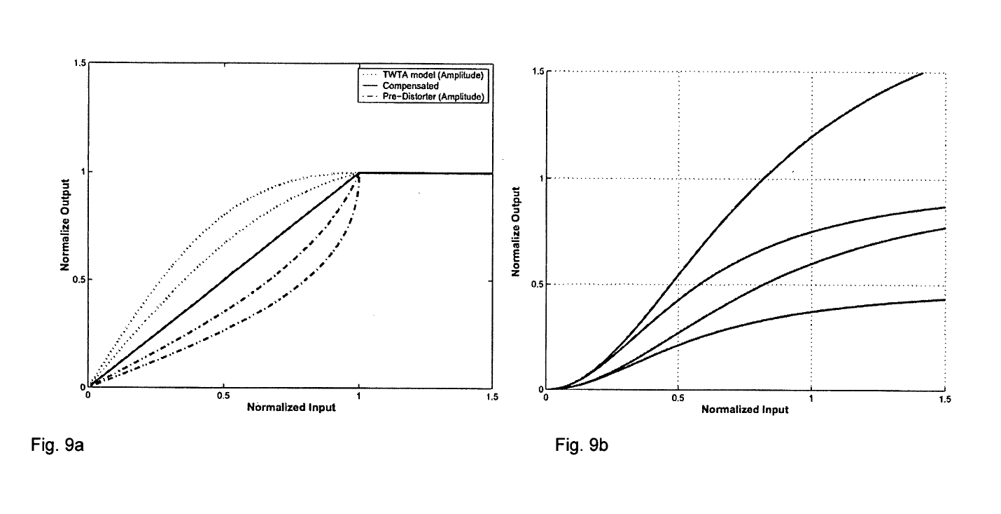

(3) Saturation condition, signal is clipped above 1, as shown in the graph of FIGS. 9a and 9b.

The reason why we choose the above conditions on amplitude and phase is to maintain normalization constraints in both input and output and the saturation condition in the above range (r>A₀), even if the amplitude is changed. These restrictions are just for convenience of representation, so in a real system, even if the above condition does not hold, our algorithm works well. Table 1 below shows errors after tracking α, β, γ, and ε using our algorithm. We used the following equations to get the results of Table 1.

$$\begin{matrix}Error ( α ) = \frac{\vert α - \hat{α} \vert}{\vert {α}_{max} - {α}_{min} \vert} , & ( 63 ) \\ Error ( β ) = \frac{\vert β - \hat{β} \vert}{\vert {β}_{max} - {β}_{min} \vert} , & ( 64 ) \\ Error ( γ ) = \frac{\vert γ - \hat{γ} \vert}{\vert {γ}_{max} - {γ}_{min} \vert} , & ( 65 ) \\ Error ( ɛ ) = \frac{\vert ɛ - \hat{ɛ} \vert}{\vert {ɛ}_{max} - {ɛ}_{min} \vert} & ( 66 )\end{matrix}$$

We get the results of Table 1, using only two training symbols, calculating 1000 times and averaging the results.

TABLE 1
Error of parameters

| Step size | Error (α) | Error (β) | Error (γ) | Error (ε) |
|---|---|---|---|---|
| 0.1 | 1.02 × 10⁻² | 2.74 × 10⁻² | 6.3 × 10⁻³ | 1.72 × 10⁻² |
| 0.01 | 9.67 × 10⁻⁴ | 2.5 × 10⁻³ | 6.04 × 10⁻⁴ | 1.7 × 10⁻³ |
| 0.001 | 9.49 × 10⁻⁵ | 2.54 × 10⁻⁴ | 6.18 × 10⁻⁵ | 1.69 × 10⁻⁴ |

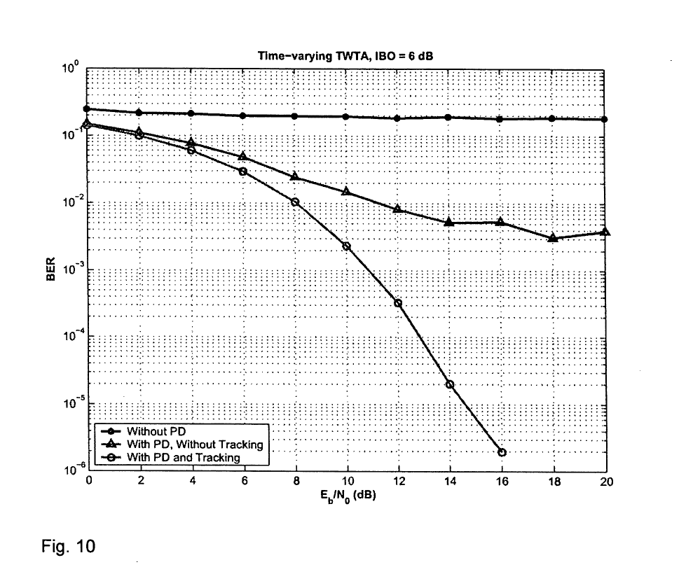

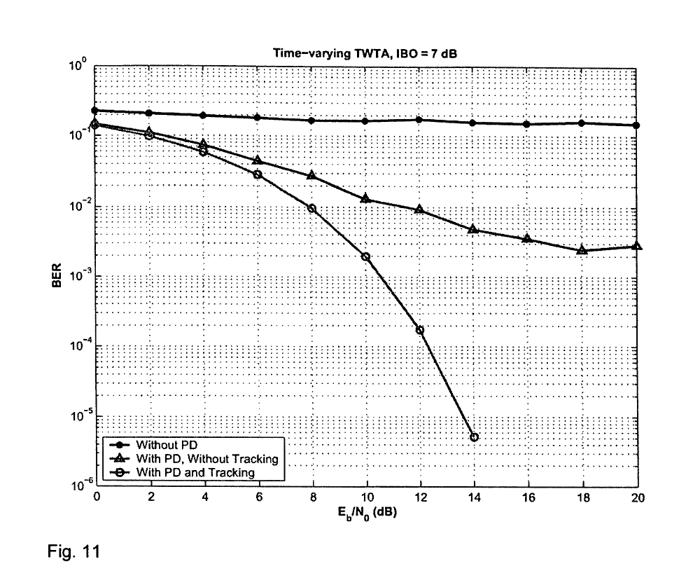

The results of Table 1 show that only two training symbols are enough for our algorithm. This indicates that our algorithm is very fast and has little delay. The BER performance of pre-distorter 14 in OFDM 10 with time-varying high power amplifier 24 is shown in the graphs of FIG. 10 and FIG. 11. In these curves, we assume step size=0.01. As is clear from FIG. 10 and FIG. 11, if the variation of high power amplifier 24 is not tracked, the performance is much worse compared with the case of tracking. The simulation results thus show that this ability to track changes in parameters adds value to system performance.

Time-Varying Adaptive Case with Gaussian Distribution and LMS Algorithm

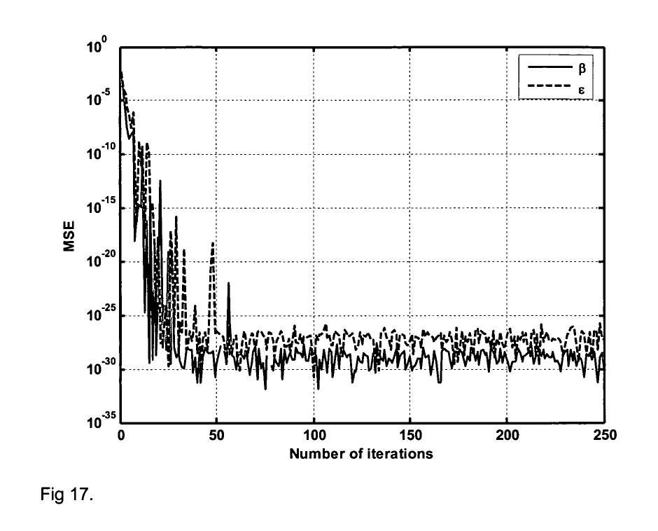

We simulate our PD again, but different parameter distribution. We assume 4 parameters α, β, γ, ε are time-varying with both Gaussian and uniform distribution and track the variation of parameters using LMS (Least Mean Square) algorithm. First we show convergence of our algorithm in FIG. 17. The reason why we show only two parameters β and ε is that, as we show in previously, once we get both β and ε, other parameters α and γ can be achieve easily. In this simulation, we assume β is uniformly distributed and ε is Gaussian distribution with mean E(ε)=2.8168 as in Saleh's original model and variance 0.01. We use step size μ_{β}=6000000 and μ_{ε}=600000000000 for fast convergence.

Now we show comparison of BER performance between with and without tracking. In these simulations, we assume that four parameters change according to the following conditions.

(1) The two parameters change in the following ranges
1.01≦α≦2 (67)
0.01≦α≦1 (68)

(2) Phase parameters γ and ε change with Gaussian distribution with averages E(γ)=2.5293, E(ε)=2.8168 and variance σ=0.1 each.

(3) Input and output normalization condition, β=α−1.

(4) Saturation condition, signal is clipped above 1, as shown in the graph of FIGS. 9a and 9b.

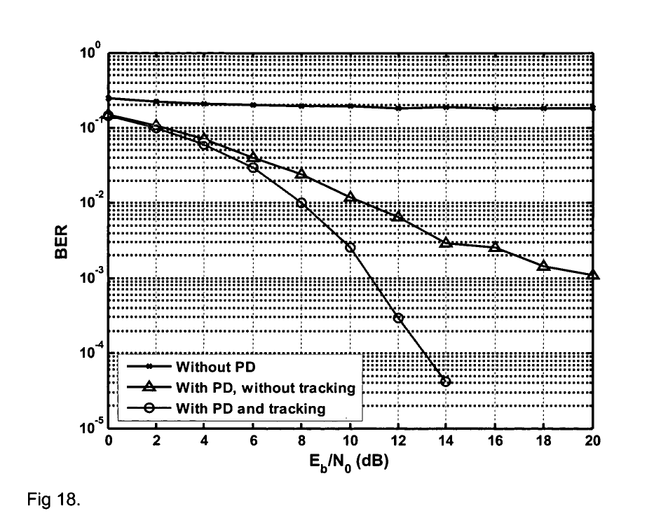

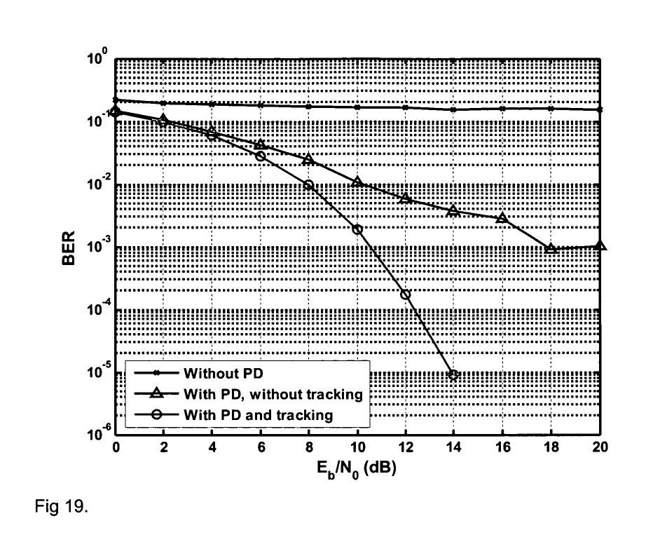

As we explained in previous section, these restrictions are only for convenience of representation. The BER performance of PD in OFDM with time-varying HPA is shown in FIG. 18 (IBO=6 dB) and FIG. 19 (IBO=6 dB). In these BER performance simulation, we assume step sizes μ_{β}=50000000=and μ_{ε}=10000000000. We use two training symbols and iterate 1000 times. Even usually PD needs much less iteration, we use enough number of iteration to make sure all of parameters are converge. As is clear from FIG. 18 and FIG. 19, if the variation of HPA is not tracked, the performance is much worse compare with the case of tracking. The simulation results thus show that this ability to track changes in parameters adds value to system performance.

Pre-Distorter for Solid State Power Amplifier

Time-Invariant Case

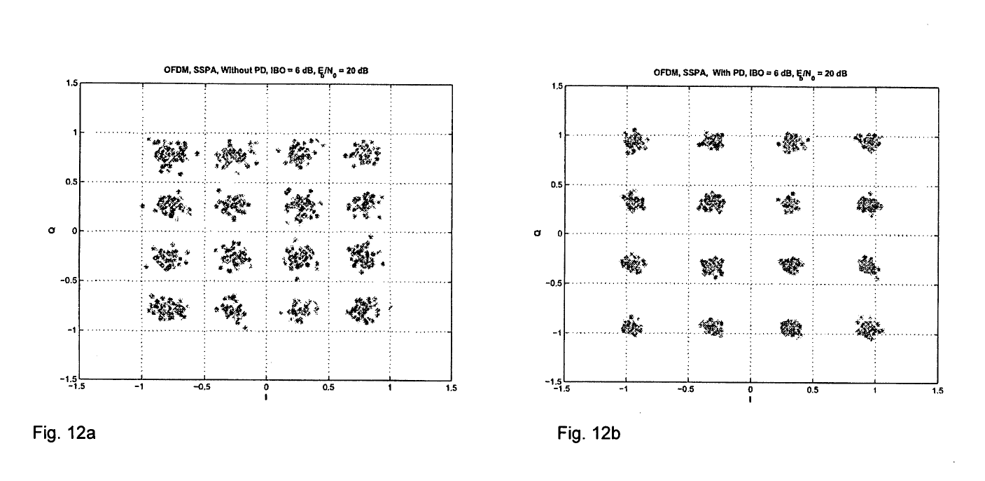

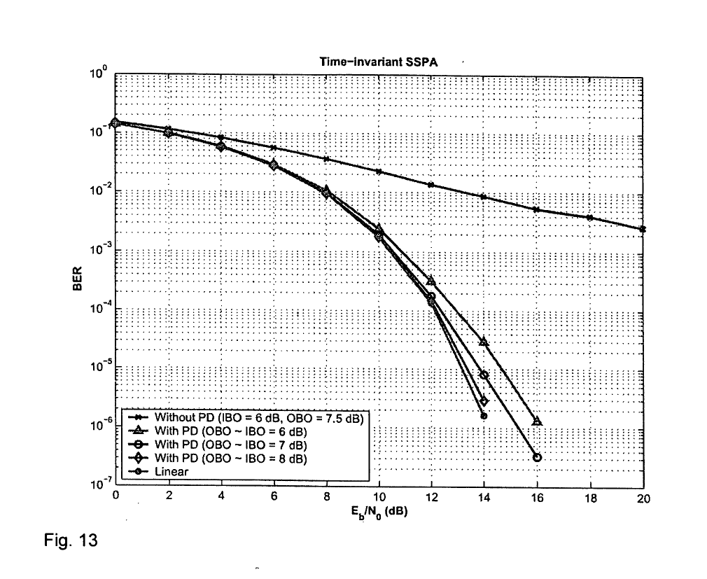

Consider OFDM simulation results with the assumption that solid state power amplifier 24 is time invariant system. In this simulation, 16 QAMs were employed as modulation scheme and used 128 sub-carriers. Because of high peak to average power ratio, OFDM needs much more IBO than single carrier system. FIGS. 12a and 12b show the signal constellation output without and with pre-distorter 14 respectively. In comparison with the traveling wave tube amplifier case, amplitude distortion is not so severe and no phase distortion exists. However, without pre-distorter 14, even if IBO=6 dB, amplitude distortion is high. In FIG. 13, the BER performance curves show that our pre-distorter 14 can significantly reduce the effect of nonlinear distortion in OFDM system 10. In FIG. 13, we use A₀=p=1.

Time-Varying Adaptive Case with Uniform Distribution

As we mentioned previously, high power amplifier 14 is time-varying system. Assume the two parameters A₀ and p are time-varying, thus we should track the variation of A₀ and p. As in the case of traveling wave tube amplifier 24, two parameters A₀ and p have uniform distribution. The simulations used a simple search algorithm. Table 2 shows errors after track A₀ and p using our algorithm. We used following
equations to get the results of Table 2.

$$\begin{matrix}Error ( {A}_{0} ) = \frac{\vert {A}_{0} - \hat{{A}_{0}} \vert}{\vert {A}_{max} - {A}_{min} \vert} , & ( 69 ) \\ Error ( p ) = \frac{\vert p - \hat{p} \vert}{\vert {p}_{max} - {p}_{min} \vert} & ( 70 )\end{matrix}$$

where Â₀ and \hat{p} are tracked parameters using simple search algorithm and |Aₘₐₓ−Aₘᵢₙ| and |pₘₐₓ−pₘᵢₙ| variation ranges. We calculate equations (69) and (70) 1000 times and average each error. According to Table 2, even step size is 0.1, the errors are very small.

TABLE 2
Error of Â₀, and \hat{p}

| Step | 1 ≦ A₀, p ≦ 1.5 | | 1 ≦ A₀, p ≦ 2 | | 1 ≦ A₀, p ≦ 3 | |
|---|---|---|---|---|---|---|
| size | Error (A₀) | Error (p) | Error (A₀) | Error (p) | Error (A₀) | Error (p) |
| 0.1 | 3.86 × 10⁻² | 5.1 × 10⁻² | 2.29 × 10⁻² | 2.56 × 10⁻² | 1.40 × 10⁻² | 1.23 × 10⁻² |
| 0.01 | 3.7 × 10⁻³ | 5.0 × 10⁻³ | 2.22 × 10⁻³ | 2.5 × 10⁻³ | 1.5 × 10⁻³ | 1.3 × 10⁻³ |
| 0.001 | 3.66 × 10⁻⁴ | 4.8875 × 10⁻⁴ | 2.1718 × 10⁻¹ | 2.4870 × 10⁻¹ | 1.4934 × 10⁻⁴ | 1.2852 × 10⁻⁴ |

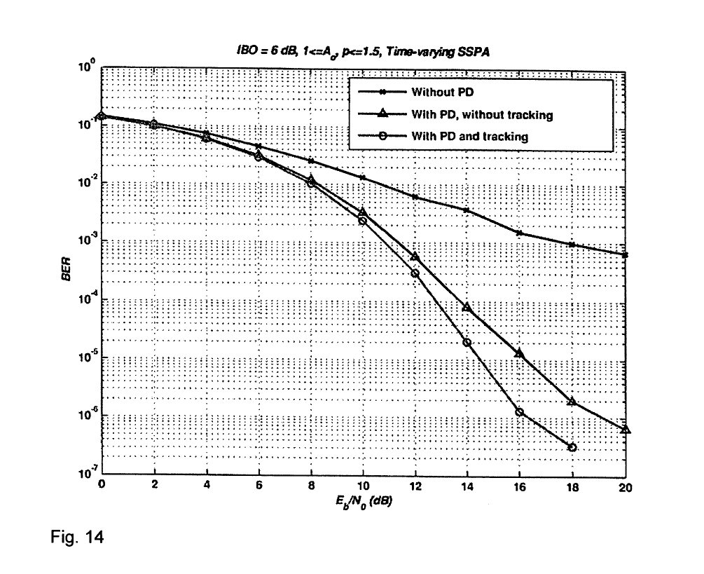

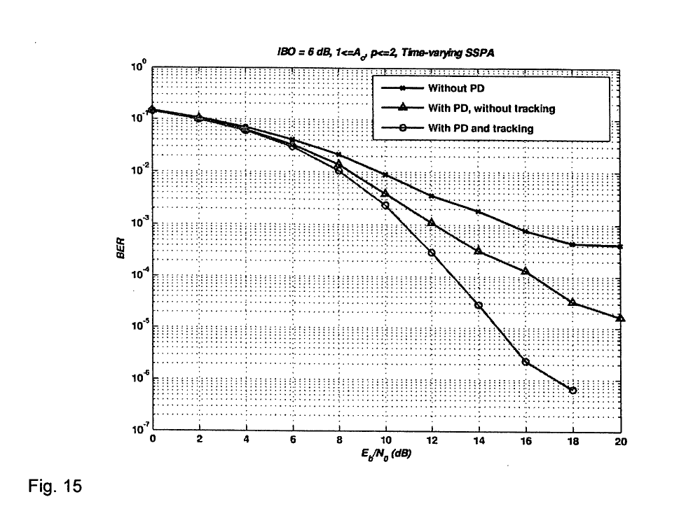

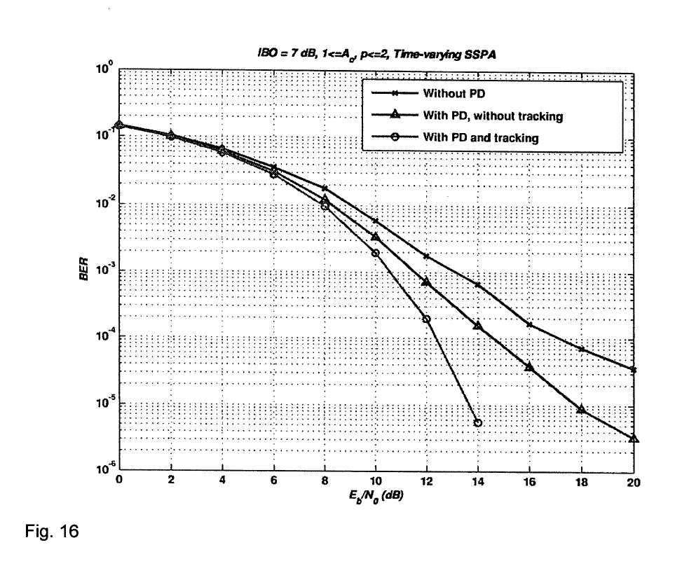

We now show BER performance of pre-distorter 14 for time-varying solid state power amplifier 24. We use a step size 0.01 in the following BER performance simulations. In FIG. 14, we assume two parameters are uniform distribution in the range 1≦A₀, p<1.5 with mean=1.25 each, IBO=6 dB. In the case of without tracking, we use mean value 1.25 for both parameters. In FIG. 15 and FIG. 16, we show BER performance of pre-distorter 14 for time-varying solid state power amplifier 24 when two parameters are uniform distribution in the wider range 1≦A₀, p<2 with mean=1.5, IBO=6 dB and 7 dB each. In the case of without tracking, we use mean value 1.5 for both parameters.

Time-Varying Adaptive Case with Gaussian Distribution

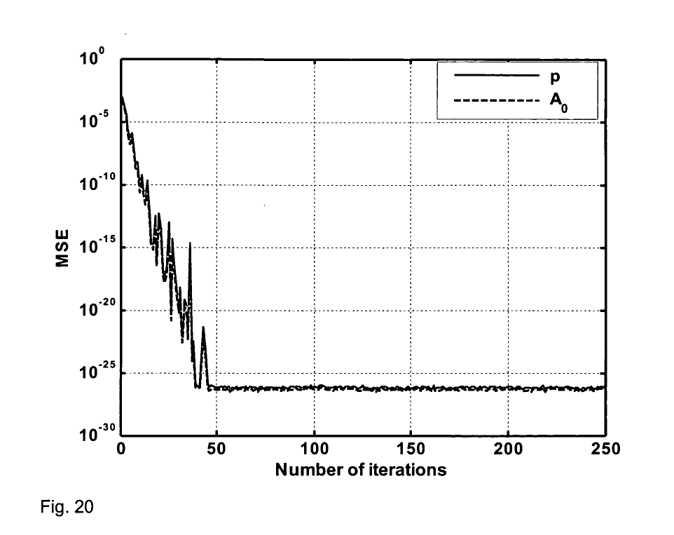

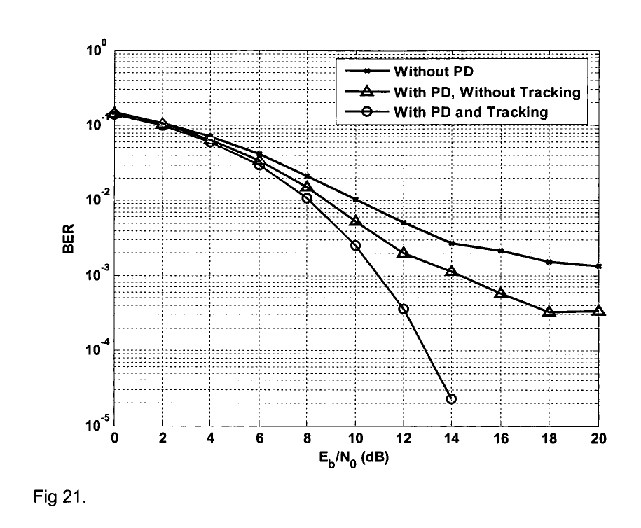

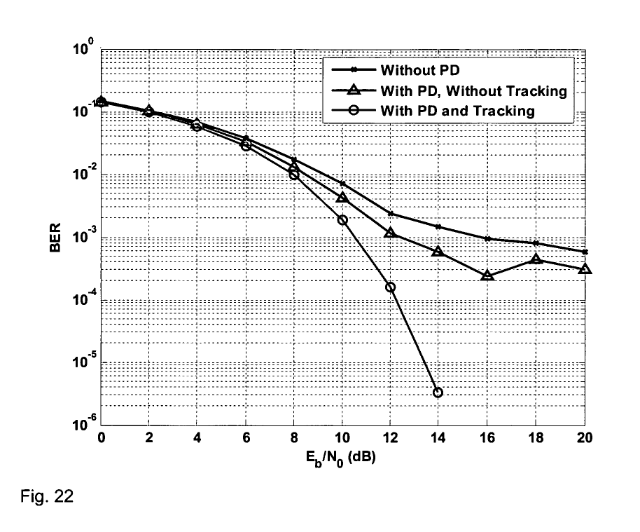

Now, we assume both parameters A0 and p are time-varying with Gaussian distribution and track the variation using LMS algorithm. First, we simulate convergence of our algorithm in FIG. 20. In this simulation, we assume two parameters A0 and p are change continuously with Gaussian distribution (Mean E(A0)=1.5, E(p)=1.5 and variance σ_{A}_{₀}=0.01, σₚ=0.01. We use step size μ_{{circumflex over (p(n)}=10000 for fast convergence. As a MSE (Mean Square Error), we calculate error 100 times each and average them. Since MSE of A0 depends on MSE of p, their MSE show similar characteristic. In the FIG. 21 (IBO=6 dB) and FIG. 22 (IBO=7 dB), we compare the case of tracking the variation of parameters p and A0, and without tracking the variation of parameters p and A0. In these simulations, we assumed two parameters p and A0 are Gaussian distribution with variance 0.1. Since, in real system, the characteristic of HPA is not change so rapidly, we assume the two parameters p and A0 change every 768 symbols and we know when the parameters may change. If the parameters change faster, then we just reduce the period of training stage to track the variance of two parameters timely. We use step size μ_{{circumflex over (p(n)}=5000 for fast convergence. In the case of without tracking, we use average values of two parameters p and A0 which 1.5 each. One more thing, we should mention is that regarding choose training symbols, we should choose symbols from nonlinear enough place in the HPA function. If input is very small, HPA operates in very close to linear situation. That is to say, this case is input=output. Then from equation (53), A0 goes to infinity and we can't find two parameters p and A0. However, HPA has always nonlinear region, (If it doesn't have nonlinear part, we don't need to use pre-distorter), we can always find two appropriate parameters p and A0.

The advantages of the model-based pre-distortion approach described above for eliminating or mitigating nonlinear distortion in time-varying high power amplifier amplifiers 24 used in OFDM-based wireless communications 10 can now be appreciated. The approach uses closed form inverses of the Saleh model of traveling wave tube amplifier and the Rapp's model of solid state power amplifier, with very few parameters required in the representation of the inverse. This sparse and yet accurate representation enables the rapid tracking of the time-varying behavior of the high power amplifier 24. These properties have been verified by simple computer simulations.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A pre-distorter in combination with a high power amplifier in a communication system comprising a digital nonlinear signal processing device of an orthogonal frequency division multiplexing (OFDM) signal, which device is placed before the high power amplifier, which power amplifier provides as high a power as possible for the OFDM signal being passed by the high power amplifier to the communication system, where the power amplifier has a normal linear range outside of which the power amplifier is nonlinear, and where the pre-distorter inverts the nonlinearity of the power amplifier, so that the combination of the pre-distorter and high power amplifier collectively exhibit a linear characteristic beyond the normal linear range of the high power amplifier, where the pre-distorter is characterized by an exact analytic expression for the description of the input-output characteristic of the pre-distorter based on an analytic model for the high power amplifier.

2. The pre-distorter of claim 1 where the high power amplifier comprises a traveling wave tube amplifier with time-varying characteristic or a solid state power amplifier with time-varying characteristic where the pre-distorter is characterized by a mixed computational/analytical algorithm for compensation of nonlinear distortion of the power amplifier.

3. The pre-distorter of claim 2 where the analytic model for the high power amplifier is a Saleh traveling wave tube amplifier model and where the computational/analytical algorithm for compensation of nonlinear distortion comprises an algorithm for analytical inversion in combination with a nonlinear parameter estimation algorithm to provide sparse and accurate representation of the pre-distorter, with the capability of tracking efficiently any rapidly time-varying behavior of the high power amplifier.

4. The pre-distorter of claim 2 where the analytic model for the high power amplifier is a Rapp's solid state power amplifier model and where the computational/analytical algorithm for compensation of nonlinear distortion comprises an algorithm for analytical inversion in combination with a nonlinear parameter estimation algorithm to provide sparse and accurate representation of the pre-distorter, with the capability of tracking efficiently any rapidly time-varying behavior of the high power amplifier.

5. The pre-distorter of claim 3 where the Saleh traveling wave tube amplifier model is used to provide an exact closed form expression for the inverse of the amplifier model represented by means of only a few parameters based on an analytical model for the traveling wave tube amplifier to derive a cogent algorithm for an estimated pre-distorter I.

6. The pre-distorter of claim 4 where Rapp's solid state power amplifier model is used to provide an exact closed form expression for the inverse of the amplifier model represented by means of only a few parameters based on an analytical model for the solid state power amplifier to derive a cogent algorithm for an estimated pre-distorter II.

7. The pre-distorter of claim 1 where the pre-distorter and power amplifier are each nonlinear zero memory devices and where the pre-distorter precomputes and cancels the nonlinear distortion present in the power amplifier.

8. The pre-distorter of claim 5 where the Saleh traveling wave tube amplifier model is represented as
$$u [ r ] = \frac{α r}{1 + β {r}^{2}}$$
$$Φ [ r ] = \frac{γ {r}^{2}}{1 + ɛ {r}^{2}}$$
where u is amplitude response, φ is phase response, r is input amplitude of the traveling wave tube amplifier and α, β, γ, and ε are four adjustable parameters.

9. The pre-distorter of claim 6 where Rapp's solid state power amplifier model is represented as
$$u [ r ] = \frac{r}{{( 1 + {( \frac{r}{{A}_{0}} )}^{2 p} )}^{\frac{1}{2 p}}}$$
$$Φ [ r ] \approx 0$$
where r is input amplitude of solid state power amplifier, A₀ is the maximum output amplitude and p is the parameter which affects the smoothness of the transition.

10. The distorter of claim 1 where the power amplifier and hence the pre-distorter is characterized by parameters α, β, γ, and ε, and where q and u denote nonlinear zero memory input and output maps respectively of the pre-distorter and high power amplifier, and xₗ(n), denotes the input of the pre-distorter, yₗ(n) denotes the output of the pre-distorter which is also the input to the high power amplifier, and z(t) the output of the high power amplifier, such that for any given power amplifier, operation of the pre-distorter is characterized by the input-output maps
u[q(xₗ(n))]=k xₗ(n)
where k is a desired pre-specified linear amplification constant, and
where the power amplifier is a traveling wave tube, and where the input and output of traveling wave tube amplifier are
y(t)=q[r(t)] cos(ω_{c}t+φ(t)+θ[r(t)])
z(t)=u[q[r(t)]] cos(ω_{c}t+φ(t)+θ[r(t)]+Φ[q(t)])
where
$$u [ q ( r ) ] = \frac{α q}{1 + β {q}^{2}}$$
$$Φ [ q ( r ) ] = \frac{γ {q}^{2}}{1 + ɛ {q}^{2}}$$
where the following relationships hold
$$\frac{α q}{1 + β {q}^{2}} = r$$
$$\frac{γ {q}^{2}}{1 + ɛ {q}^{2}} = - θ$$
$$r β {q}^{2} - α q + r = 0$$
to yield
$$q ( r ) = \frac{α - \sqrt{{α}^{2} - 4 {r}^{2} β}}{2 r β} , r \leq 1$$
where parameters α, β, γ, and ε change with time so that
$$α E ( \frac{{q}^{4}}{{( 1 + β {q}^{2} )}^{3}} ) = E ( \frac{{q}^{3} u}{{( 1 + β {q}^{2} )}^{2}} )$$
where E is expectation with respect to β and
$$A ( β ) = E ( \frac{{q}^{2}}{{( 1 + β {q}^{2} )}^{2}} )$$
$$B ( β ) = E ( \frac{qu}{1 + β {q}^{2}} )$$
$$C ( β ) = E ( \frac{{q}^{4}}{{( 1 + β {q}^{2} )}^{3}} )$$
$$D ( β ) = E ( \frac{{q}^{3} u}{{( 1 + β {q}^{2} )}^{2}} )$$
so that
$$α = \frac{B ( β )}{A ( β )}$$
$$\frac{B ( β )}{A ( β )} C ( β ) = D ( β )$$
which is solved numerically for {circumflex over (β, which is the estimate of β, and then {circumflex over (β is used in
$$α = \frac{B ( β )}{A ( β )}$$
to obtain {circumflex over (α, an estimate for a and the estimates then generated as defined by
$$\begin{matrix}\hat{A} ( β ) = \frac{1}{N} {\sum }_{n = 1}^{N} \frac{{q}_{n}^{2}}{{( 1 + β {q}_{n}^{2} )}^{2}} \\ \hat{B} ( β ) = \frac{1}{N} {\sum }_{n = 1}^{N} \frac{{q}_{n} {u}_{n}}{1 + β {q}_{n}^{2}} \\ \hat{C} ( β ) = \frac{1}{N} {\sum }_{n = 1}^{N} \frac{{q}_{n}^{4}}{{( 1 + β {q}_{n}^{2} )}^{3}} \\ \hat{D} ( β ) = \frac{1}{N} {\sum }_{n = 1}^{N} \frac{{q}_{n}^{3} {u}_{n}}{{( 1 + β {q}_{n}^{2} )}^{2}}\end{matrix}$$
and further estimating γ and ε according to a similar manner,
obtaining the optimal estimation of β, using
{circumflex over (βₒₚₜ=min_{β}|B(β)C(β)−A(β)D(β)|²
where the optimal coefficient {circumflex over (βₒₚₜ, satisfies {circumflex over (βₒₚₜ=min_{β}|B(β)C(β)−A(β)D(β)|² which is determined in order to minimize the MSE (Mean Square Error) defined by
J(β)=E[{circumflex over (B(β){circumflex over (C(β)−{circumflex over (A(β){circumflex over (D(β)]²
where J is cost function to be minimized and E is expectation with respect to β
obtaining the derivative of J with respect to β using
$$\frac{\partial J ( β )}{\partial β} = 2 E ( \hat{B} ( β ) \hat{C} ( β ) - \hat{A} ( β ) \hat{D} ( β ) ) \cdot ( \frac{\partial \hat{B} ( β )}{\partial β} \hat{C} ( β ) + \hat{B} ( β ) \frac{\partial \hat{C} ( β )}{\partial β} - \frac{\partial \hat{A} ( β )}{\partial β} \hat{D} ( β ) - \hat{A} ( β ) \frac{\partial \hat{D} ( β )}{\partial β} )$$
where
$$\begin{matrix}\frac{\partial \hat{A} ( β )}{\partial β} = - \frac{2}{N} {\sum }_{n = 1}^{N} \frac{{q}_{n}^{4}}{{( 1 + β {q}_{n}^{2} )}^{3}} \\ \frac{\partial \hat{B} ( β )}{\partial β} = - \frac{1}{N} {\sum }_{n = 1}^{N} \frac{{q}_{n}^{3} {u}_{n}}{{( 1 + β {q}_{n}^{2} )}^{2}} \\ \frac{\partial \hat{C} ( β )}{\partial β} = - \frac{3}{N} {\sum }_{n = 1}^{N} \frac{{q}_{n}^{6}}{{( 1 + β {q}_{n}^{2} )}^{4}} \\ \frac{\partial \hat{D} ( β )}{\partial β} = - \frac{2}{N} {\sum }_{n = 1}^{N} \frac{{q}_{n}^{5} {u}_{n}}{{( 1 + β {q}_{n}^{2} )}^{3}}\end{matrix}$$
using a LMS (Least Mean Square) algorithm represented as
$$\hat{β} ( n + 1 ) = \hat{β} ( n ) - {μ}_{\hat{β}} \cdot ( \hat{B} ( \hat{β} ( n ) ) \hat{C} ( \hat{β} ( n ) ) - \hat{A} ( \hat{β} ( n ) ) \hat{D} ( \hat{β} ( n ) ) ) \cdot ( \frac{\partial \hat{B} ( \hat{β} ( n ) )}{\partial \hat{β} ( n )} \hat{C} ( \hat{β} ( n ) ) + \hat{B} ( \hat{β} ( n ) ) \frac{\partial \hat{C} ( \hat{β} ( n ) )}{\partial \hat{β} ( n )} - \frac{\partial \hat{A} ( \hat{β} ( n ) )}{\partial \hat{β} ( n )} \hat{D} ( \hat{β} ( n ) ) - \hat{A} ( \hat{β} ( n ) ) \frac{\partial \hat{D} ( \hat{β} ( n ) )}{\partial \hat{β} ( n )} )$$
after obtaining an estimation of β, obtaining an estimation of α from
$$α = \frac{B ( β )}{A ( β )} .$$
γ and ε using the same sequence of above operations.

11. The pre-distorter of claim 1 where the power amplifier is characterized by parameters α, β, γ, and ε, and further comprising a digital signal processor coupled between the power amplifier and the pre-distorter for generating estimated parameters {circumflex over (α, {circumflex over (β, {circumflex over (γ, and {circumflex over (ε of the power amplifier to control the pre-distorter in a time varying fashion.

12. The pre-distorter of claim 1 where the pre-distorter is characterized by at least two parameters, and further comprising a digital signal processor coupled between the power amplifier and the pre-distorter for generating at least two estimated parameters of the pre-distorter to control the pre-distorter in a time varying fashion in response to the time varying power amplifier.

13. The distorter of claim 10 where zero phase distortion is obtained
θ(r)+Φ(q)=0
so that
$$θ ( r ) = - Φ ( q ) = - \frac{{γ ( q ( r ) )}^{2}}{1 + {ɛ ( q ( r ) )}^{2}} .$$

14. The distorter of claim 1 where q and u denote nonlinear zero memory input and output maps respectively of the pre-distorter and high power amplifier, and xₗ(n), denotes the input of the pre-distorter, yₗ(n) denotes the output of the pre-distorter which is also the input to the high power amplifier, and z(t) the output of the high power amplifier, such that for any given power amplifier, operation of the pre-distorter is characterized by the input-output maps
u[q(xₗ(n))]=k xₗ(n)
where k is a desired pre-specified linear amplification constant, and
where the power amplifier is a solid state power amplifier characterized by parameters A₀ and p which change with time,
where the input of the pre-distorter is denoted as q(n) and the output of the pre-distorter is denoted as u(n),
where during a training stage, it is assumed that pre-distorter is turned off so that the input and output of the pre-distorter is same r(n)=q(n),.
where a MSE (Mean Square Error) for LMS (Least Mean Square) algorithm is employed to generate A₀ and p in which
$${A}_{0} = \frac{q \cdot u}{{( {q}^{2 p} - {u}^{2 p} )}^{\frac{1}{2 p}}}$$
so that given p, A₀ is generated as a function of time by sending two training symbols to provide a known input q to the high power amplifier and obtain an output amplitude u of the high power amplifier to generate two different estimations of A₀, namely A₀₁ and A₀₂.
$${A}_{01} = \frac{{q}_{1} \cdot {u}_{1}}{{( {q}_{1}^{2 p} - {u}_{1}^{2 p} )}^{\frac{1}{2 p}}}$$
$${A}_{02} = \frac{{q}_{2} \cdot {u}_{2}}{{( {q}_{2}^{2 p} - {u}_{2}^{2 p} )}^{\frac{1}{2 p}}}$$
where q₁, u₁ are output amplitudes of the pre-distorter and high power amplifier each for first training symbol and q₂, u₂ are output amplitudes of the pre-distorter and high power amplifier each for second training symbol to estimate unknown A₀ and p using
{circumflex over (pₒₚₜ=minₚ|A₀₁(p)−A₀₂(p)|²
Â₀=A₀₁({circumflex over (pₒₚₜ)—A₀₂({circumflex over (popt)
where {circumflex over (pₒₚₜ is an optimum estimate p and an estimate of A₀ are generated so that an LMS (Least Mean Square) algorithm tracks time variation of p and an optimum coefficient {circumflex over (pₒₚₜ is determined in order to minimize the MSE (Mean Square Error) criteria defined by
J(p)=E(A₀₁(p)−A₀₂(p))²
and the LMS algorithm to estimate p is represented as
$$\hat{p} ( n + 1 ) = \hat{p} ( n ) - {μ}_{\hat{p} ( n )} \cdot ( {A}_{01} ( \hat{p} ( n ) ) - {A}_{02} ( \hat{p} ( n ) ) ) \cdot ( \frac{\partial {A}_{01} ( \hat{p} ( n ) )}{\partial \hat{p} ( n )} - \frac{\partial {A}_{02} ( \hat{p} ( n ) )}{\partial \hat{p} ( n )} )$$
where μ_{{circumflex over (p(n)} is the step size of LMS algorithm.

15. The distorter of claim 1 where q and u denote nonlinear zero memory input and output maps respectively of the pre-distorter and high power amplifier, and xₗ(n), denotes the input of the pre-distorter, yₗ(n) denotes the output of the pre-distorter which is also the input to the high power amplifier, and z(t) the output of the high power amplifier, such that for any given power amplifier, operation of the pre-distorter is characterized by the input-output maps
u[q(xₗ(n))]=k xₗ(n)
where k is a desired pre-specified linear amplification constant, and
where the power amplifier is a solid state power amplifier characterized by parameters A₀ and p which change with time, where the input of the pre-distorter is denoted as q(n) and the output of the pre-distorter is denoted as u(n),
where during a training stage, it is assumed that pre-distorter is turned off so that the input and output of the pre-distorter is same r(n)=q(n),.
where a MSE (Mean Square Error) for LMS (Least Mean Square) algorithm is employed to generate A₀ and p in which
$${A}_{0} = \frac{q \cdot u}{{( {q}^{2 p} - {u}^{2 p} )}^{\frac{1}{2 p}}}$$
so that for a given p, A₀ is generated, where both A₀ and p change with time
where two training symbols are sent to the distorter so that input amplitude q and the output amplitude u of the high power amplifier is known,
where corresponding to two different training symbols, two different estimations of A₀, namely A₀₁ and A₀₂ are generated, where a p is chosen which is nearly constant during the training period in the high power amplifier, the two different estimations of A₀, namely A₀₁ and A₀₂, have almost the same value or due to step size, very close values, so that a value for p can be found, which yields the smallest distance between two estimated A₀, namely Dₘᵢₙ=A₀₁−A₀₂|² and from the estimation of p, Â₀=A₀₁≈A₀₂ from the minimum distance Dₘᵢₙ=A₀₁−A₀₂ |² using only two training symbols and no iteration.

16. A method of operating a pre-distorter which is placed before a high power amplifier in a communication system where the power amplifier has a normal linear range outside of which the power amplifier is nonlinear comprising:
providing an orthogonal frequency division multiplexing(OFDM) signal;
pre-distorting the OFDM signal by means of the pre-distorter by inverting OFDM signal as determined by the nonlinearity of the power amplifier, where operation of the pre-distorter is characterized by an exact analytic expression for the description of the input-output characteristic of the pre-distorter based on an analytic model for the high power amplifier; and amplifying the pre-distorted the OFDM signal with the power amplifier to as high a power as possible for the OFDM signal being passed by the high power amplifier to the communication system, so that the combination of the pre-distorter and high power amplifier collectively exhibit a linear characteristic beyond the normal linear range of the high power amplifier,.

17. The method of claim 16 where the high power amplifier comprises a traveling wave tube amplifier with time-varying characteristic a or solid state power amplifier with time-varying characteristic and where pre-distorting the OFDM signal by means of the pre-distorter comprises using a mixed computational/analytical algorithm for compensation of nonlinear distortion of the power amplifier.

18. The method of claim 17 where the analytic model for the high power amplifier is a Saleh traveling wave tube amplifier model and where using a mixed computational/analytical algorithm comprises analytical inverting and using a nonlinear parameter estimation algorithm to provide sparse and accurate representation of the pre-distorter, with the capability of tracking efficiently any rapidly time-varying behavior of the high power amplifier.

19. The method of claim 17 where the analytic model for the high power amplifier is a Rapp's solid state power amplifier model and where using a mixed computational/analytical algorithm comprises analytically inverting and using a nonlinear parameter estimation algorithm to provide sparse and accurate representation of the pre-distorter, with the capability of tracking efficiently any rapidly time-varying behavior of the high power amplifier.

20. The method of claim 18 further comprising using the Saleh traveling wave tube amplifier model to provide an exact closed form expression for the inverse of the amplifier model represented by means of only a few parameters based on an analytical model for the traveling wave tube amplifier to derive a cogent algorithm for an estimated pre-distorter 1.

21. The method of claim 19 further comprising using Rapp's solid state power amplifier model to provide an exact closed form expression for the inverse of the amplifier model represented by means of only a few parameters based on an analytical model for the solid state power amplifier to derive a cogent algorithm for an estimated pre-distorter II.

22. The method of claim 16 where the pre-distorter and power amplifier are each nonlinear zero memory devices where pre-distorting the OFDM signal by means of the pre-distorter comprises pre-computing and canceling the nonlinear distortion present in the power amplifier.

23. The method of claim 20 where using the Saleh traveling wave tube amplifier model comprises modeling the power amplifier using
$$u [ r ] = \frac{α r}{1 + β {r}^{2}}$$
$$Φ [ r ] = \frac{γ {r}^{2}}{1 + ɛ {r}^{2}}$$
where u is amplitude response, φ is phase response, r is input amplitude of the traveling wave tube amplifier and α, β, γ, and ε are four adjustable parameters.

24. The method of claim 21 where using Rapp's solid state power amplifier model comprises modeling the power amplifier using
$$u [ r ] = \frac{r}{{( 1 + {( \frac{r}{{A}_{0}} )}^{2 p} )}^{\frac{1}{2 p}}}$$
$$Φ [ r ] \approx 0$$
where r is input amplitude of solid state power amplifier, A₀ is the maximum output amplitude and p is the parameter which affects the smoothness of the transition.

25. The method of claim 16 where pre-distorting the OFDM signal by means of the pre-distorter comprises characterizing the power amplifier and hence the pr-distorter by parameters α, β, γ, and ε, and where q and u denote nonlinear zero memory input and output maps respectively of the pre-distorter and power amplifier, and xₗ(n), denotes the input of the pre-distorter, yₗ(n) denotes the output of the pre-distorter which is also the input to the high power amplifier, and z(t) the output of the high power amplifier, and such that for any given power amplifier, operating the pre-distorter according to the input-output maps
u[q(xₗ(n))]=k xₗ(n)
where k is a desired pre-specified linear amplification constant, and
where the power amplifier is a traveling wave tube, and operating the traveling wave tube amplifier so that the input and output of traveling wave tube amplifier are
y(t)=q[r(t)]cos(ω_{c}t+φ(t)+θ[r(t)])
z(t)=u[q[r(t)]]cos(ω_{c}t+φ(t)+θ[r(t)]+Φ[q(t)])
where
$$u [ q ( r ) ] = \frac{α q}{1 + β {q}^{2}}$$
$$Φ [ q ( r ) ] = \frac{γ {q}^{2}}{1 + ɛ {q}^{2}}$$
where the following relationships hold
$$\frac{α q}{1 + β {q}^{2}} = r$$
$$\frac{γ {q}^{2}}{1 + ɛ {q}^{2}} = - θ$$
$$r β {q}^{2} - α q + r = 0$$
to yield
$$q ( r ) = \frac{α - \sqrt{{α}^{2} - 4 {r}^{2} β}}{2 r β} , r \leq 1$$
where parameters α, β, γ, and ε change with time so that
$$α E ( \frac{{q}^{4}}{{( 1 + β {q}^{2} )}^{3}} ) = E ( \frac{{q}^{3} u}{{( 1 + β {q}^{2} )}^{2}} )$$
Where E is expectation w.r.t. β and
$$A ( β ) = E ( \frac{{q}^{2}}{{( 1 + β {q}^{2} )}^{2}} )$$
$$B ( β ) = E ( \frac{qu}{1 + β {q}^{2}} )$$
$$C ( β ) = E ( \frac{{q}^{4}}{{( 1 + β {q}^{2} )}^{3}} )$$
$$D ( β ) = E ( \frac{{q}^{3} u}{{( 1 + β {q}^{2} )}^{2}} )$$
so that
$$α = \frac{B ( β )}{A ( β )}$$
$$\frac{B ( β )}{A ( β )} C ( β ) = D ( β )$$
solving numerically for {circumflex over (β, which is the estimate of β, and then using {circumflex over (β in
$$α = \frac{B ( β )}{A ( β )}$$
to to obtain {circumflex over (α, an estimate for α, generating the estimates as defined by
$$\begin{matrix}\hat{A} ( β ) = \frac{1}{N} {\sum }_{n = 1}^{N} \frac{{q}_{n}^{2}}{{( 1 + β {q}_{n}^{2} )}^{2}} \\ \hat{B} ( β ) = \frac{1}{N} {\sum }_{n = 1}^{N} \frac{{q}_{n} {u}_{n}}{1 + β {q}_{n}^{2}} \\ \hat{C} ( β ) = \frac{1}{N} {\sum }_{n = 1}^{N} \frac{{q}_{n}^{4}}{{( 1 + β {q}_{n}^{2} )}^{3}} \\ \hat{D} ( β ) = \frac{1}{N} {\sum }_{n = 1}^{N} \frac{{q}_{n}^{3} {u}_{n}}{{( 1 + β {q}_{n}^{2} )}^{2}}\end{matrix}$$
and further estimating γ and ε in the same manner,
obtaining the optimum estimation of β, using
{circumflex over (βₒₚₜ=min_{β}|B(β)C(β)−A(β)D(β)|²
where the optimum coefficient {circumflex over (βₒₚₜ, satisfyies {circumflex over (βₒₚₜ=min_{β}|B(β)C(β)−A(β)D(β)|² which is determined in order to minimize the MSE (Mean Square Error) defined by
J(β)=E[{circumflex over (B(β)Ĉ(β)−Â(β){circumflex over (D(β)]²
where J is cost function to be minimized and E is expectation with respect to β
obtaining the derivative of J with respect to β
$$\frac{\partial J ( β )}{\partial β} = 2 E ( \hat{B} ( β ) \hat{C} ( β ) - \hat{A} ( β ) \hat{D} ( β ) ) \cdot ( \frac{\partial \hat{B} ( β )}{\partial β} \hat{C} ( β ) + \hat{B} ( β ) \frac{\partial \hat{C} ( β )}{\partial β} - \frac{\partial \hat{A} ( β )}{\partial β} \hat{D} ( β ) - \hat{A} ( β ) \frac{\partial \hat{D} ( β )}{\partial β} )$$
where
$$\begin{matrix}\frac{\partial \hat{A} ( β )}{\partial β} = - \frac{2}{N} {\sum }_{n = 1}^{N} \frac{{q}_{n}^{4}}{{( 1 + β {q}_{n}^{2} )}^{3}} \\ \frac{\partial \hat{B} ( β )}{\partial β} = - \frac{1}{N} {\sum }_{n = 1}^{N} \frac{{q}_{n}^{3} {u}_{n}}{{( 1 + β {q}_{n}^{2} )}^{2}} \\ \frac{\partial \hat{C} ( β )}{\partial β} = - \frac{3}{N} {\sum }_{n = 1}^{N} \frac{{q}_{n}^{6}}{{( 1 + β {q}_{n}^{2} )}^{4}} \\ \frac{\partial \hat{D} ( β )}{\partial β} = - \frac{2}{N} {\sum }_{n = 1}^{N} \frac{{q}_{n}^{5} {u}_{n}}{{( 1 + β {q}_{n}^{2} )}^{3}}\end{matrix}$$
using a LMS (Least Mean Square) algorithm represented as
$$\hat{β} ( n + 1 ) = \hat{β} ( n ) - {μ}_{\hat{β}} \cdot ( \hat{B} ( \hat{β} ( n ) ) \hat{C} ( \hat{β} ( n ) ) - \hat{A} ( \hat{β} ( n ) ) \hat{D} ( \hat{β} ( n ) ) ) \cdot ( \frac{\partial \hat{B} ( \hat{β} ( n ) )}{\partial \hat{β} ( n )} \hat{C} ( \hat{β} ( n ) ) + \hat{B} ( \hat{β} ( n ) ) \frac{\partial \hat{C} ( \hat{β} ( n ) )}{\partial \hat{β} ( n )} - \frac{\partial \hat{A} ( \hat{β} ( n ) )}{\partial \hat{β} ( n )} \hat{D} ( \hat{β} ( n ) ) - \hat{A} ( \hat{β} ( n ) ) \frac{\partial \hat{D} ( \hat{β} ( n ) )}{\partial \hat{β} ( n )} )$$
to obtain an estimation of β,
obtaining an estimation of α from
$$α = \frac{B ( β )}{A ( β )} .$$
and estimating γ and ε using the same approach.

26. The method of claim 16 where pre-distorting the OFDM signal by means of the pre-distorter comprises characterizing the power amplifier by time varying parameters α, β, γ, and ε, and generating estimated parameters {circumflex over (α, {circumflex over (β, {circumflex over (γ, and {circumflex over (ε of the power amplifier to control the pre-distorter in a time varying fashion.

27. The method of claim 16 where pre-distorting the OFDM signal by means of the pre-distorter comprises characterizing the power amplifier by at least two time varying parameters, and generating at least two estimated parameters of the power amplifier to control the pre-distorter in a time varying fashion.

28. The method of claim 25 where pre-distorting the OFDM signal by means of the pre-distorter comprises providing for zero phase distortion so that
$$θ ( r ) + Φ ( q ) = 0$$
$$and$$
$$θ ( r ) = - Φ ( q ) = - \frac{{γ ( q ( r ) )}^{2}}{1 + {ɛ ( q ( r ) )}^{2}} .$$

29. The method of claim 16 where pre-distorting the OFDM signal by means of the pre-distorter comprises using q and u to denote nonlinear zero memory input and output maps respectively of the pre-distorter and high power amplifier, and xₗ(n), to denote the input of the pre-distorter, yₗ(n) to denote the output of the pre-distorter which is also the input to the high power amplifier, and z(t) the output of the high power amplifier, such that for any given power amplifier, operating the pre-distorter according to the input-output maps
u[q(xₗ(n))]=k xₗ(n)
where k is a desired pre-specified linear amplification constant, and characterizing the power amplifier as a solid state power amplifier by parameters A₀ and p which change with time,
where the input of the pre-distorter is denoted as q(n) and the output of the pre-distorter is denoted as u(n), providing a training stage, during which it is assumed that pre-distorter is turned off so that the input and output of the pre-distorter is same r(n)=q(n),
generating A₀ and p using a MSE (Mean Square Error) for LMS (Least Mean Square) algorithm in which
$${A}_{0} = \frac{q \cdot u}{{( {q}^{2 p} - {u}^{2 p} )}^{\frac{1}{2 p}}}$$
so that given p, A₀ is generated as a function of time by sending two training symbols to provide a known input q to the power amplifier and obtaining an output amplitude u of the power amplifier to generate two different estimations of A₀, namely A₀₁ and A₀₂.
$${A}_{01} = \frac{{q}_{1} \cdot {u}_{1}}{{( {q}_{1}^{2 p} - {u}_{1}^{2 p} )}^{\frac{1}{2 p}}}$$
$${A}_{02} = \frac{{q}_{2} \cdot {u}_{2}}{{( {q}_{2}^{2 p} - {u}_{2}^{2 p} )}^{\frac{1}{2 p}}}$$
where q₁, u₁ are output amplitudes of the pre-distorter and power amplifier each for first a training symbol and q₂, u₂ are output amplitudes of the pre-distorter and power amplifier each for a second training symbol,
estimating unknown A₀ and p using
{circumflex over (pₒₚₜ=minₚ|A₀₁(p)−A₀₂(p)|²
Â₀=A₀₁({circumflex over (pₒₚₜ)≈A₀₂({circumflex over (pₒₚₜ)
where {circumflex over (pₒₚₜ is an optimum estimate p and generating an estimate of A₀′ tracking time variation of p using an LMS (Least Mean Square) algorithm and determining an optimum coefficient {circumflex over (pₒₚₜ in order to minimize the MSE (Mean Square Error) criteria defined by
J(p)=E(A₀₁(p)−A₀₂(p))²
and estimating p using the LMS algorithm with
$$\hat{p} ( n + 1 ) = \hat{p} ( n ) - {μ}_{\hat{p} ( n )} \cdot ( {A}_{01} ( \hat{p} ( n ) ) - {A}_{02} ( \hat{p} ( n ) ) ) \cdot ( \frac{\partial {A}_{01} ( \hat{p} ( n ) )}{\partial \hat{p} ( n )} - \frac{\partial {A}_{02} ( \hat{p} ( n ) )}{\partial \hat{p} ( n )} )$$
where μ_{{circumflex over (p(n)} is the step size of LMS algorithm.

30. The method of claim 16 where pre-distorting the OFDM signal by means of the pre-distorter comprises using q and u to denote nonlinear zero memory input and output maps respectively of the pre-distorter and high power amplifier, and xₗ(n), to denote the input of the pre-distorter, yₗ(n) to denote the output of the pre-distorter which is also the input to the high power amplifier, and z(t) the output of the high power amplifier, such that for any given power amplifier, operating the pre-distorter according to the input-output maps
u[q(xₗ(n))]=k xₗ(n)
where k is a desired pre-specified linear amplification constant, and characterizing the power amplifier as a solid state power amplifier with parameters A₀ and p which change with time,
where the input of the pre-distorter is denoted as q(n) and the output of the pre-distorter is denoted as u(n), providing a training stage, during which it is assumed that pre-distorter is turned off so that the input and output of the pre-distorter is same r(n)=q(n),. generating A₀ and p using a MSE (Mean Square Error) for LMS (Least Mean Square) algorithm in which
$${A}_{0} = \frac{q \cdot u}{{( {q}^{2 p} - {u}^{2 p} )}^{\frac{1}{2 p}}}$$
so that for a given p, A₀ is generated, where both A₀ and p change with time
sending two training symbols to the distorter so that input amplitude q and the output amplitude u of the high power amplifier is known,
generating two different estimations of A₀, namely A₀₁ and A₀₂ corresponding to two different training symbols,
choosing a p which is nearly constant during the training period in the high power amplifier, the two different estimations of A₀, namely A₀₁ and A₀₂, having almost the same value or due to step size, very close values, and
finding a value for p, which yields the smallest distance between two estimated A₀, namely Dₘᵢₙ=|A₀₁−A₀₂|² and from the estimation of p, Â₀=A₀₁≈A₀₂ from the minimum distance D_{min=|A}₀₁−A₀₂|² using only two training symbols and no iteration.
